(19) United States
(12) Patent Application Publication
(10) Pub. No.: US 2024/0103715 A1
(43) Pub. Date: Mar. 28, 2024

(54) Touchscreen Jog Wheel User Interface Element

(71) Applicant: Apple Inc., Cupertino, CA (US)

(72) Inventors: Michael Fleischhauer, Morgan Hill, CA (US); David Karp, Berkeley, CA (US); Itrat U Khan, San Jose, CA (US); Kenneth C Meehan, Emerald Hills, CA (US)

(73) Assignee: Apple Inc., Cupertino, CA (US)

(21) Appl. No.: 18/470,294

(22) Filed: Sep. 19, 2023

Related U.S. Application Data
(60) Provisional application No. 63/409,625, filed on Sep. 23, 2022.

(51) Int. Cl. G06F 3/04886

(52) U.S. Cl. CPC G06F 3/04886

(57) ABSTRACT

In some implementations, at least a partial view of a jog wheel user interface (UI) element is displayed on a graphical user interface (GUI). The jog wheel UI element is operable to manipulate one or more secondary elements. In response to a touch input for controlling the jog wheel UI element, a rotation of the jog wheel UI element is animated concurrently with manipulation of the secondary element(s). In some embodiments, the jog wheel UI element is rotated at an initial rotational speed based on the touch input, continues rotating after cessation of the touch input, and is reduced until it reaches zero. In one embodiment, a distance between the contact of the touch input and the jog wheel UI element is used to determine a degree of rotation of jog wheel UI element.

### INCORPORATION BY REFERENCE; DISCLAIMER

The following application is hereby incorporated by reference: application no. 63/409,625 filed on Sep. 23, 2022. The Applicant hereby rescinds any disclaimer of claim scope in the parent application(s) or the prosecution history thereof and advises the USPTO that the claims in this application may be broader than any claim in the parent application(s).

### TECHNICAL FIELD

The disclosure generally relates to a jog wheel user interface (UI) element for providing various user input to an application or operating system.

### BACKGROUND

Many high-end graphics editing and video editing software applications are best executed on desktop computers utilizing a keyboard and mouse for navigating through the application. These types of applications often rely on precise input from the users, which is difficult to provide using other input methods.

### Overview

In some embodiments, at least a partial view of a jog wheel user interface (UI) element is displayed on a graphical user interface (GUI), with the jog wheel UI element being operable to manipulate one or more secondary elements. In response to a touch swipe input for controlling the jog wheel UI element, a rotation of the jog wheel UI element is animated based on the touch swipe input. Rotation of the jog wheel UI element includes rotating the jog wheel UI element at an initial rotational speed that is based on the touch swipe input, and subsequent to cessation of the touch swipe input, a rotational speed of the jog wheel UI element is reduced until the rotational speed of the jog wheel UI element reaches zero. Concurrently with animating the rotation of the jog wheel UI element, the display of media content item(s) is continuously modified, with a rate of modification corresponding to the rotational speed of the jog wheel UI element.

In an embodiment, a computing device, such as a tablet or pad device having a touchscreen display, presents a jog wheel UI element and an arrangement of media content item(s) on a GUI. The computing device receives a touch input at a first region of the GUI and responsive to the touch input, performs some operations. The operations include determining a distance between the touch input and the jog wheel UI element, selecting a modification to the arrangement of the media content item(s), and animating a rotation of the jog wheel UI element for a period of time concurrently with animating the modification to the arrangement of the media content item(s).

Particular embodiments provide at least the following advantages. A user of a tablet or pad computing device is able to interact with elements displayed to a GUI without vision of the elements being manipulated being obscured by the user's thumb, finger, or input device. Instead, the jog wheel UI element provides a convenient, fast, and accurate method of providing input to the computing device, via a touchscreen display, for controlling elements of the GUI, along with a myriad of other functionality. Moreover, a granularity of manipulation of the secondary element based on touch input received by the jog wheel UI element is much finer than is possible through touch input manipulation of the secondary elements themselves.

In one or more embodiments, user input for rotating the jog wheel UI element results in updating a display associated with media content item(s). Updating the display may include, for example, modifying media content item(s), traversing media content item(s), selecting media content item(s), and selecting positions along a timeline associated with the media item(s).

Details of one or more embodiments are set forth in the accompanying drawings and the description below. Other features, aspects, and potential advantages will be apparent from the description and drawings, and from the claims.

### DESCRIPTION OF DRAWINGS

FIG. 1 is a simplified illustration of an example graphical user interface (GUI) showing a jog wheel user interface (UI) element, in one or more embodiments.

FIG. 2 is a simplified illustration of an example GUI showing a jog wheel UI element, in one or more embodiments.

FIG. 3 is a simplified illustration of an example GUI showing a touch input on a jog wheel UI element, in one or more embodiments.

FIG. 4 is a simplified illustration of an example GUI showing a touch input on a jog wheel UI element, in one or more embodiments.

FIG. 5 is a simplified illustration of an example GUI showing a touch input on a jog wheel UI element, in one or more embodiments.

FIG. 6 is a simplified illustration of an example GUI showing multiple jog wheel UI elements, in one or more embodiments.

FIG. 7 is a simplified illustration of an example GUI showing a jog wheel UI element, in one or more embodiments.

FIG. 8 is a simplified illustration of an example GUI showing a jog wheel UI element, in one or more embodiments.

FIG. 9 is a simplified illustration of an example GUI showing a jog wheel UI element, in one or more embodiments.

FIG. 10 is a simplified illustration of an example GUI showing a jog wheel UI element, in one or more embodiments.

FIG. 11 is a simplified illustration of an example GUI showing a jog wheel UI element, in one or more embodiments.

FIG. 12 is a simplified illustration of an example GUI showing a jog wheel UI element, in one or more embodiments.

FIG. 13 is a simplified illustration of an example GUI showing a jog wheel UI element, in one or more embodiments.

FIG. 14 is a simplified illustration of an example GUI showing a touch input on a jog wheel UI element, in one or more embodiments.

FIG. 15 is a simplified illustration of an example GUI showing a touch input on a jog wheel UI element, in one or more embodiments.

FIG. 16 is flow diagram of an example process for interacting with a GUI using a jog wheel UI element, in one or more embodiments.

FIG. 17 is flow diagram of an example process for interacting with a GUI using a jog wheel UI element, in one or more embodiments.

FIG. 18 is flow diagram of an example process for interacting with a GUI using a jog wheel UI element, in one or more embodiments.

FIG. 19 is flow diagram of an example process for interacting with a GUI using a jog wheel UI element, in one or more embodiments.

FIG. 20 is flow diagram of an example process for interacting with a GUI using a jog wheel UI element, in one or more embodiments.

FIG. 21 is a block diagram of an example computing device that can implement the features and processes of FIGS. 1-20.

FIGS. 22A-22R illustrate various examples of a selectable and/or informational UI elements alone or in association with an example jog wheel UI element.

Like reference symbols in the various drawings indicate like elements.

### DETAILED DESCRIPTION

### Jog Wheel UI Element

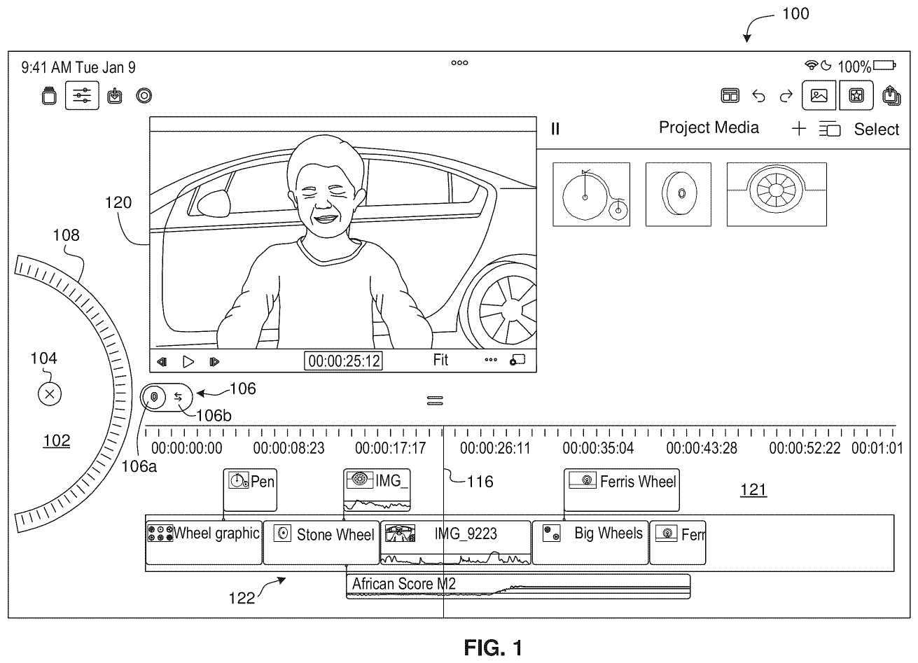

FIG. 1 is a simplified illustration of an example GUI 100 showing a jog wheel UI element 102 in one or more embodiments. A jog wheel UI element 102 may be referred to in the instant Specification and corresponding Figures as a “jog wheel” for ease of readability. Accordingly, a “jog wheel” when referred to herein should be interpreted as a jog wheel UI element. The jog wheel UI element 102 may have any shape capable of being rotated about an axis of rotation (a center of a full circle about which the circle rotates). Some example shapes include, but are not limited to a circle, an oval, an ellipse, a gear-like shape, a shape similar to a watch bezel, a continuous disk, a hollow disk, a multi-side polygon, a knob, a dial, etc. In some examples, a three-dimensional shape may be used, such as a sphere, an ellipsoid, a toroid, a torus, a genus g surface, etc. In further embodiments, a partial view of the shape of the jog wheel UI element 102 may be shown in the GUI 100. In some approaches, the jog wheel UI element 102 may be partially displayed on the GUI 100. For example, when the jog wheel UI element 102 is shaped like a circle or disk, GUI 100 may display a portion of the full circle jog wheel UI element 102, e.g., approximately a quarter circle (90°), approximately a half circle (180°), approximately a three-quarter circle (270°), etc.

In FIG. 1, GUI 100 displays a partial view of the jog wheel UI element 102 (appearing as approximately a half circle) with an outer edge 108 of the jog wheel UI element 102 having disposed therein a plurality of tick marks to denote rotation of the jog wheel UI element 102 and a current position of the jog wheel UI element 102. The jog wheel UI element 102 may include more or less tick marks on the outer edge 108 than shown in FIG. 1, in various approaches. Moreover, the tick marks may have different sizes and shapes than shown in FIG. 1. For example, triangles, rectangles, circles, or any other shapes may be used for tick marks. In some approaches, the jog wheel UI element 102 and/or individual tick marks may have one or more indicators associated therewith, such as an angle of rotation, numbers indicating a parameter setting, minimum and/or maximum settings, etc.

The jog wheel UI element 102 is configured to respond to touch input by a user of GUI 100. Accordingly, in some embodiments, GUI 100 is configured for display on a touchscreen display. Responsive to certain touch input(s), the jog wheel UI element 102 will rotate about its axis of rotation (which may appear on GUI 100, be located outside of GUI 100, or may be positioned on GUI 100 but not displayed). How the jog wheel UI element 102 rotates may be based on any of the following: aspects of the jog wheel UI element 102, one or more characteristics of the touch input, one or more aspects of the GUI, user settings, etc.

A touch input may include a swipe touch input, a tap touch input, a drag and drop touch input, a double tap touch input, a multiple-point touch input (where multiple points of contact are made to the touchscreen display concurrently), a non-contact “hover” touch input, a multi-pressure touch input (where a pressure intensity of the touch input varies from one touch input to another, or varies in pressure intensity during a same touch input), or any other touch input capable of being sensed by a touchscreen interface (such as a touchscreen display).

For example, a tap input received by the jog wheel UI element 102 may cause selection of a second element displayed on GUI 100 that is highlighted or otherwise marked for selection prior to the tap input. In an example, a hover touch input over a particular region of GUI 100 may cause the jog wheel UI element 102 to be invoked from a closed or hidden state, thereby allowing a user to interact with the jog wheel UI element 102. In another example, a double tap touch input may cause a time period displayed by a timeline in a media editing application to be altered, such as increasing/decreasing the scale of time displayed by the timeline making fine granularity manipulation of media content items displayed by the timeline to be harder/easier, depending on how the scale of the timeline has changed. In an example, a hard pressure touch input may cause faster movement, while a softer pressure touch input may cause slower movement, or vice versa. According to an example, a swipe touch input on the jog wheel UI element 102 in conjunction with a concurrent tap touch input received at another position in GUI 100 may cause selection of an element positioned at the tap touch input and manipulation of the selected element based on the swipe touch input received by the jog wheel UI element 102.

The jog wheel UI element 102, in some embodiments, may be associated with one or more additional UI elements, each of which may have one or more sub-elements associated therewith. FIG. 1 shows a UI element 104 which is configured to close and/or hide the jog wheel UI element 102 in response to touch input received by UI element 104. UI element 104 is shown as a circle with an “X” disposed therein, but any shape, graphic, icon, and/or text may be used to denote an action that is selectable through UI element 104.

In some embodiments, UI element 104 may function to close and/or hide the jog wheel UI element 102 when the jog wheel UI element 102 is open and operational; however, when the jog wheel UI element 102 is closed or hidden, UI element 104 may be displayed on GUI 100 and operable to open and/or restore the jog wheel UI element 102.

In some embodiments, UI element 106 may be associated with the jog wheel UI element 102. UI element 106 may include any number of sub-elements (e.g., sub-element 106a, sub-element 106b, etc.), with each sub-element 106a, 106b being configured to perform a designated task or function. For example, sub-element 106a may be selectable by a user (e.g., via touch input), and upon selection, lock the jog wheel UI element 102 in a current position on the GUI relative to other displayed content. In another example, sub-element 106b may be selectable by a user (e.g., via touch input), and upon selection, invert a functional response to rotation of the jog wheel UI element 102 (e.g., clockwise rotation may cause one action, while counter-clockwise rotation may cause an opposite action). Selection of sub-element 106b may switch the response to the same direction of rotating the jog wheel UI element 102.

In various approaches, a function, appearance, design, or some other aspect of the jog wheel UI element 102 may be modified, deleted, added, and/or altered in some way. The allowable changes may be pre-set and selectable by a user (e.g., from a displayed list, via voice command, with a touch input gesture, through a preferences or settings menu, etc.). In one approach, one or more UI elements associated with the jog wheel UI element 102 that are displayed on GUI 100 may be configured to modify, delete, add, and/or alter the jog wheel UI element 102.

Some example aspects of the jog wheel UI element 102 that may be manipulated include, but are not limited to, a color of the jog wheel UI element 102, a size of the jog wheel UI element 102, a position of the jog wheel UI element 102 on the GUI 100, an input response direction of the jog wheel UI element 100, a sensitivity of the jog wheel UI element 100, a number of jog wheel UI elements displayed on the GUI 100, a transparency of the jog wheel UI element 102, an overlay characteristic of the jog wheel UI element 102, inertia of the jog wheel UI element 102, methods for revealing and hiding the jog wheel UI element 102, a portion of the jog wheel UI element 102 to display on the GUI 100, etc. These various aspects will be described in more detail in relation to other Figures.

In various embodiments, more or less UI elements may be associated with the jog wheel UI element 102 than those shown in FIG. 1. Moreover, functionality associated with any of the UI elements associated with the jog wheel UI element 102 may vary from those described herein in one or more embodiments.

### Jog Wheel Inputs

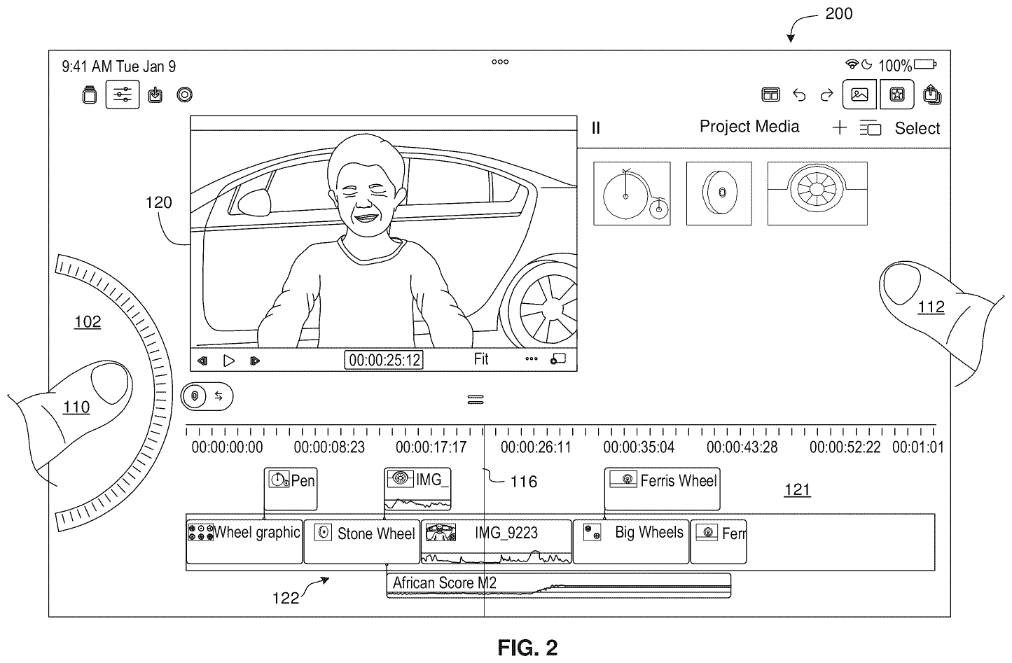

FIG. 2 is a simplified illustration of an example GUI 200 showing a jog wheel UI element 102 in one or more embodiments. GUI 200 and the jog wheel UI element 102 may be configured for display on a touchscreen display, such as a tablet or pad computing device. The pad computing device may be positioned on a surface or mount for interaction by a user and/or held by a user. When a user holds a pad computing device, the user's hands may be placed on a left and right side of the pad computing device. As shown in FIG. 2, thumb 110 is positioned proximate to the jog wheel UI element 102 on the left side of GUI while thumb 112 is positioned on an opposite side of GUI 200 (the right side) simulating a user holding the pad computing device (with the remaining fingers of the user's hands being hidden underneath the pad computing device below GUI 200). This orientation represents a tablet or pad computing device being held by the user, where the user provides input to a touchscreen display of the tablet or pad via the user's thumbs 110, 112. Although thumbs 110, 112 are shown for input, any finger and/or instrument (stylus, knuckle, palm, fingernail, etc.) may be used to provide input to the various GUIs and the jog wheel UI elements described in the various Figures. For the remainder of the descriptions of the Figures, a thumb will be shown to represent a touch input location.

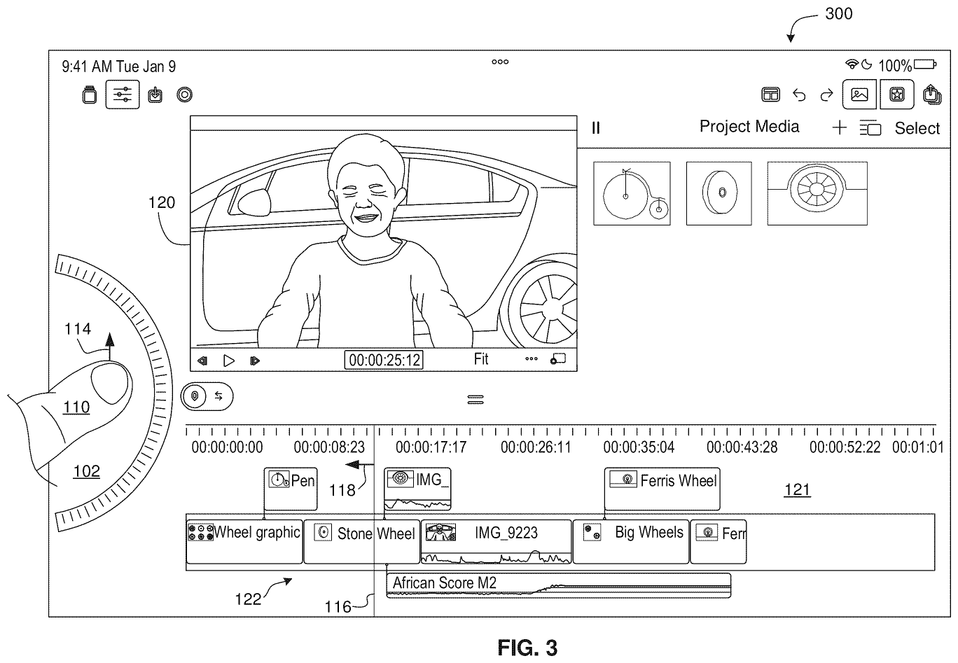

FIG. 3 is a simplified illustration of an example GUI 300 showing a touch input on the jog wheel UI element 102 in one or more embodiments. Thumb 110 provides a swipe touch input 114 in an upward direction relative to an orientation of other elements shown on GUI 300 (e.g., a video player 120 showing a child in front of a car). GUI 300 shows a media editing application, but use of the jog wheel UI element 102 is not limited to such an environment. The jog wheel UI element 102 may be utilized in any application or operating system environment where precise control of a secondary element is desired and/or useful.

In the media editing application, video player 120 displays a current visual content corresponding to a position of a current position indicator 116 along a timeline 121. The timeline 121 is a time-based arrangement of media content items 122 (e.g., Wheel graphic, Stone Wheel, Ferris Wheel, IMG_9223, etc.) positioned at certain points in time that together form a media presentation (which may include various types of media content items, e.g., video clips, animation clips, audio clips, images, filters, transitions, etc.). On timeline 121, earlier time is shown to the left while later time is shown to the right, with a series of tick marks and time-based indicators providing context as to where in a media presentation the current position indicator 116 is positioned.

In FIG. 3, in some embodiments, touch input 114 received by the jog wheel UI element 102 may result in several operations being performed. In one embodiment, touch input 114 being received by the jog wheel UI element 102 results in the current position indicator 116 being moved along the timeline 121 in a direction that corresponds to a direction of movement indicated by touch input 114. As shown, touch input 114 is in an upward direction, which is translated to leftward movement 118 of the current position indicator 116 along the timeline 121. As shown, the current position indicator 116 has moved relative to the media content items 122 dispersed on the timeline 121 to be positioned over the “Stone Wheel” media clip from its initial position shown in FIG. 2 over the “IMG_9223” media clip due to touch input 114 being received by the jog wheel UI element 102.

In an embodiment, touch input 114 being received by the jog wheel UI element 102 results in rotation of the jog wheel UI element 102 in a direction that corresponds to a direction of movement indicated by touch input 114. Because touch input 114 is in an upward direction, it may be translated to counter-clockwise movement of the jog wheel UI element 102.

In other embodiments, an upward touch input 114 may result in clockwise rotation of the jog wheel UI element 102. In an embodiment, an upward touch input 114 may result in rightward movement of the current position indicator 116 along the timeline 121.

In or more embodiments, a position of the jog wheel UI element 102 is used to map user input to rotation of the jog wheel UI element 102. As an example, when a jog wheel UI element 102 is located on a left side of the GUI 300, an upward motion results in a counter-clockwise rotation of the jog wheel UI element 102 and a downward motion results in a clockwise rotation of the jog wheel UI element 102. When a user drags the same jog wheel UI element 102 to the right side of the interface, the computing device modifies the mapping of the user input to the rotation of the jog wheel UI element 102. While the jog wheel UI element 102 is located on the right side of the GUI 300, an upward motion results in clockwise rotation while a downward motion of the jog wheel results in a counter-clockwise rotation of the jog wheel UI element 102.

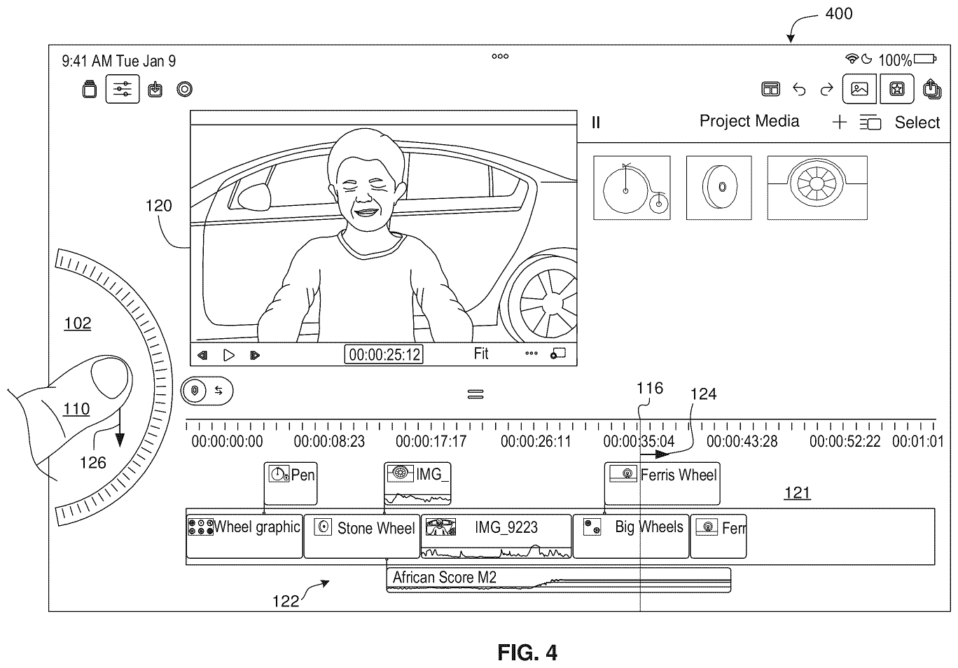

FIG. 4 is a simplified illustration of an example GUI 400 showing a touch input on a jog wheel UI element, in one or more embodiments. Thumb 110 provides a swipe touch input 126 in a downward direction relative to an orientation of other elements shown on GUI 400 (e.g., video player 120 showing a child in front of a car).

In some embodiments, touch input 126 received by the jog wheel UI element 102 may result in several operations being performed. In one embodiment, touch input 126 being received by the jog wheel UI element 102 results in the current position indicator 116 being moved along the timeline 121 in a direction that corresponds to a direction of movement indicated by touch input 126. As shown, touch input 126 is in a downward direction, which is translated to rightward movement 124 of the current position indicator 116 along the timeline 121. As shown, the current position indicator 116 has moved relative to the media content items 122 dispersed on the timeline 121 to be positioned over the “Ferris Wheel” media clip from its initial position shown in FIG. 2 over the “IMG_9223” media clip due to touch input 126 being received by the jog wheel UI element 102.

In an embodiment, touch input 126 being received by the jog wheel UI element 102 results in rotation of the jog wheel UI element 102 in a direction that corresponds to a direction of movement indicated by touch input 126. Because touch input 126 is in a downward direction, it may be translated to clockwise movement of the jog wheel UI element 102.

In other embodiments, a downward touch input 126 may result in counter-clockwise rotation of the jog wheel UI element 102. In an embodiment, a downward touch input 126 may result in leftward movement of the current position indicator 116 along the timeline 121.

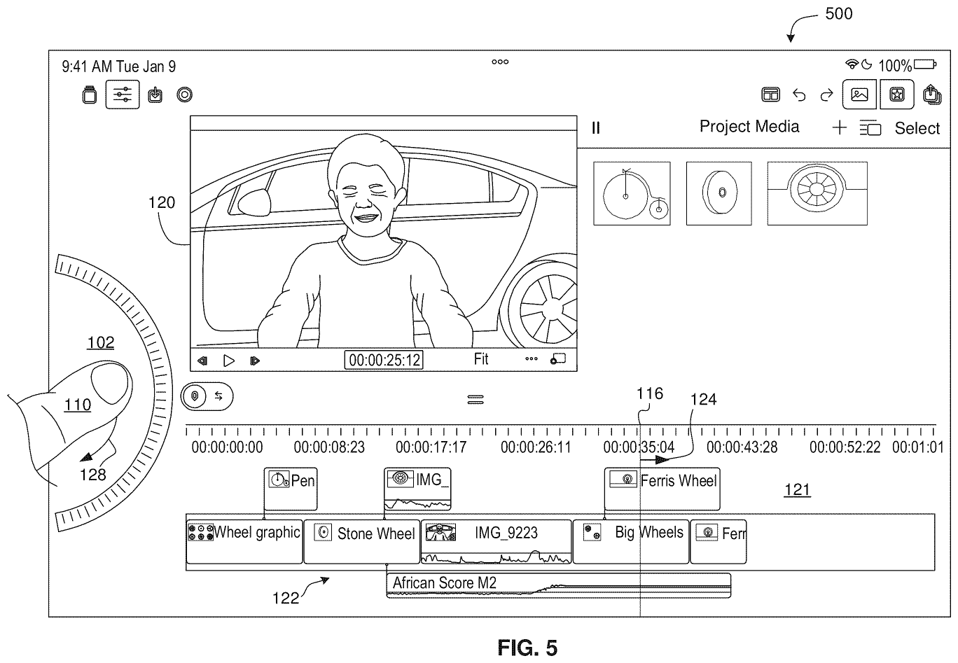

FIG. 5 is a simplified illustration of an example GUI 500 showing a touch input on a jog wheel UI element, in one or more embodiments. Thumb 110 provides a swipe touch input 128 in a rounded downward direction similar to the curvature of the jog wheel UI element 102. This curved touch input 128 is recognized by the jog wheel UI element 102 based on the movement from an initial contact point to a last contact point, along with a corresponding direction of the movement (in this case, down and to the left).

In some embodiments, touch input 128 received by the jog wheel UI element 102 may result in several operations being performed. These operations will be the same as those described in FIG. 4, in that a curved touch input 128 is recognized and treated the same as linear or straight touch inputs (like touch input 126 in FIG. 4).

In one embodiment, touch input 128 being received by the jog wheel UI element 102 results in the current position indicator 116 being moved along the timeline 121 in a direction that corresponds to a direction of movement indicated by touch input 128. As shown, touch input 128 is in a downward direction, which is translated to rightward movement 124 of the current position indicator 116 along the timeline 121. As shown, the current position indicator 116 has moved relative to the media content items 122 dispersed on the timeline 121 to be positioned over the “Ferris Wheel” media clip from its initial position shown in FIG. 2 over the “IMG_9223” media clip due to touch input 128 being received by the jog wheel UI element 102. Moreover, the portion of video that is displayed in video player 120 may be updated based on the current position within the media presentation (which is formed by the combination of the media content items 122 arranged according to the timeline 121). However, the portion of the media presentation shown in the video player 120 does not change across the various Figures described herein for simplicity, which does not limit this functionality in the embodiments described herein.

In an embodiment, touch input 128 being received by the jog wheel UI element 102 results in rotation of the jog wheel UI element 102 in a direction that corresponds to a direction of movement indicated by touch input 128. Because touch input 128 is in a downward direction, it may be translated to clockwise movement of the jog wheel UI element 102.

In other embodiments, a downward touch input 128 may result in counter-clockwise rotation of the jog wheel UI element 102. In an embodiment, a downward touch input 128 may result in leftward movement of the current position indicator 116 along the timeline 121.

In some embodiments, a position of the touch input upon the jog wheel UI element 102 may cause changes in how the touch input is translated into movement or manipulation of other elements in the GUI, as is described in more detail later.

In one or more embodiments, rotation of the jog wheel UI element 102 may be interrupted and/or stopped in response to manipulation of a secondary element (such as moving through a media content item, traversing the timeline 121, etc.) reaching a stop flag. A stop flag may include a bookmark, end or beginning of content, a chapter divider, page break, section break, a keyword being searched for in text, etc. Once a stop flag is reached by the secondary element being manipulated, rotation of the jog wheel UI element 102 will end, indicating arrival at the stop flag. The user may move past the stop flag, in one approach, by providing another touch input in the same direction as previously moved. When another stop flag is reached, the same procedure may be used (e.g., stopping the jog wheel UI element 102, receiving another touch input, and moving past the stop flag).

In a similar embodiment, if a user attempts to manipulate a secondary element by rotating the jog wheel UI element 102, and the secondary element has reached a limit (e.g., volume of a media content item increased to a maximum volume, media content moved to an end of the timeline 121, object positioned at an edge of the GUI 500, etc.), rotation of the jog wheel UI element 102 will stop, indicating that the secondary element being manipulated has reached a limit. Any further attempt to move past this limit will cause the jog wheel UI element 102 to resist the movement, and possibly provide audible and/or haptic feedback to the user indicating the limit has been reached.

### Multiple Jog Wheel UI Elements

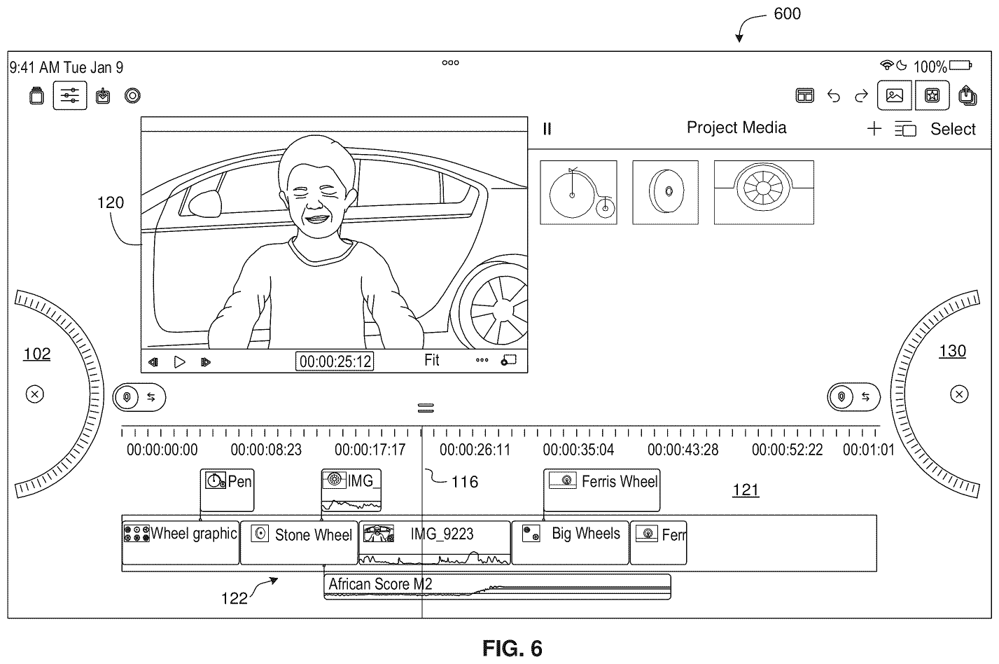

FIG. 6 is a simplified illustration of an example GUI 600 showing multiple jog wheel UI elements, in one or more embodiments. Jog wheel UI element 102 is shown on a left side of GUI 600, while concurrently displayed on GUI 600 is a second jog wheel UI element 130 displayed on a right side of GUI 600. The controls, design, and appearance of the second jog wheel UI element 130 is reversed to that of jog wheel UI element 102, thereby making the second jog wheel UI element 130 operable by a right thumb, finger, or hand of a user.

Each of the jog wheel UI elements 102, 130 may have the same appearance, may be reverse images of one another, or may have different appearances. In another embodiment, the jog wheel UI elements 102, 130 may perform the same functions or different functions. For example, the jog wheel UI element 102 may be configured to manipulate media content items 122 upon the timeline 121, while the second jog wheel UI element 130 may be configured for navigating through a list, catalog, or directory of material to add into the media presentation.

In another embodiment, multiple jog wheel UI elements may be nested and share a common axis of rotation. In this embodiment, an inner jog wheel UI element may be separately manipulated by a touch input from an outer jog wheel UI element. Each of the nested jog wheel UI elements may have a distinct look and feel to set them apart from one another, or may have a consistent look and feel. Moreover, the nested jog wheel UI elements may perform different functionality, either for the same secondary element on the GUI or for different elements of the GUI.

In an example, an inner jog wheel UI element may control a current position indicator 116 along the timeline 121, while the outer jog wheel UI element may control a position of a selected media content item relative to the timeline 121.

In another example, an inner jog wheel UI element may control selection of a media content item from the available media content items from “Project Media,” while the outer jog wheel UI element may control one or more visual parameters of a selected content media item (e.g., color, hue, brightness, contrast, filter applied, etc.).

### Portion of Jog Wheel UI Element Displayed

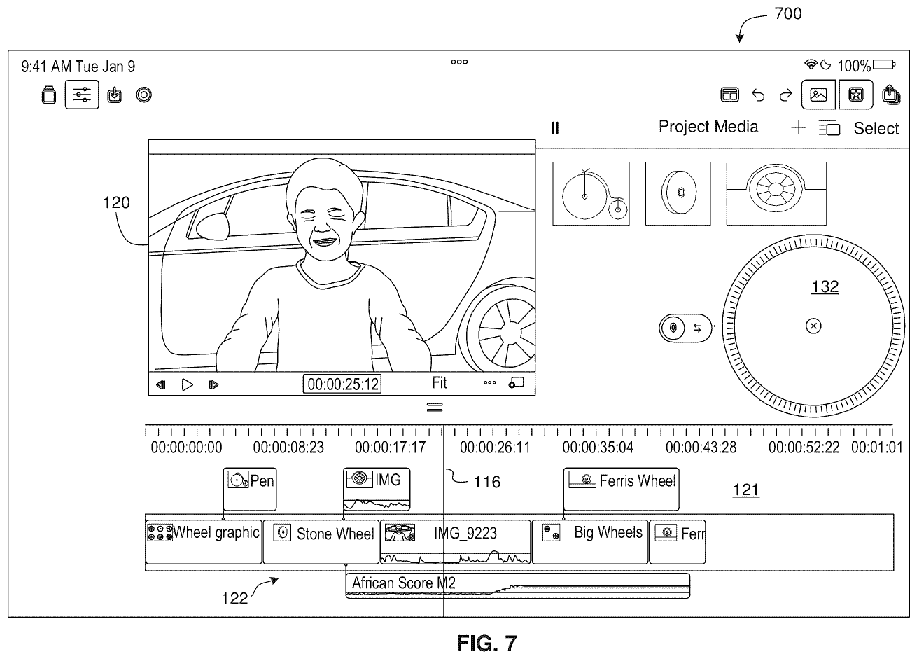

Any portion of a complete visual representation of a jog wheel may be included in a display upon a GUI. The jog wheel UI elements shown in FIGS. 1-6 were partial displays that included approximately half of a circle (e.g., about 90°). FIG. 7 is a simplified illustration of an example GUI 700 showing a jog wheel UI element 132 as a full circle, in one or more embodiments. Operation of the jog wheel UI element 132 proceeds as described previously, in that linear and/or rounded touch inputs may be received and translated into a rotation of the jog wheel UI element 132. Based on the degree of rotation of the jog wheel UI element 132, one or more secondary elements within GUI 700 may be manipulated, such as by moving the current position indicator 116, adjusting a volume of one or more media content items 122, moving a relative position of one or more media content items 122, changing a length of one or more media content items 122, etc.

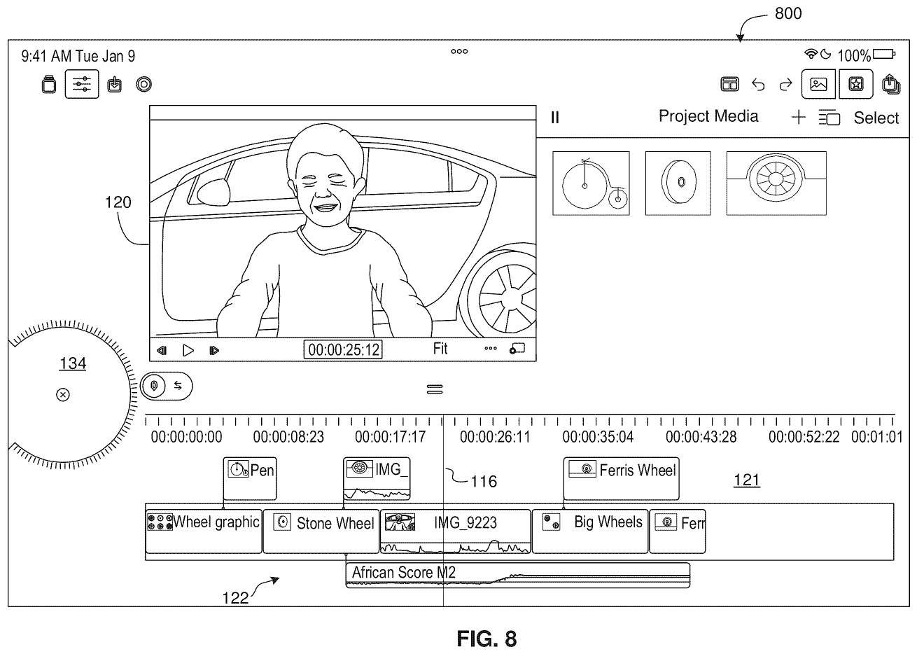

FIG. 8 is a simplified illustration of an example GUI 800 showing a jog wheel UI element 134 as a majority of a circle, in one or more embodiments. Specifically, the jog wheel UI element 134 displays approximately 270° of a circle. Operation of the jog wheel UI element 134 proceeds as described previously, in that linear and/or rounded touch inputs may be received and translated into a rotation of the jog wheel UI element 134. Based on the degree of rotation of the jog wheel UI element 134, one or more secondary elements within GUI 700 may be manipulated, such as by clipping one or more media content items 122, expanding one or more media content items 122, navigating through a catalog of additional media content to place on the timeline 121, etc.

### Jog Wheel UI Element Overlay

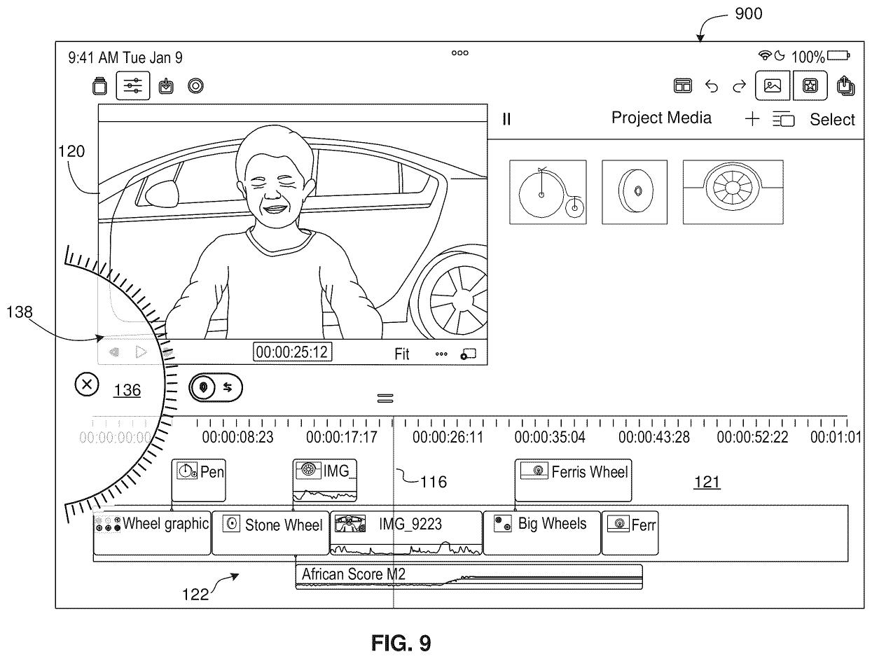

FIG. 9 is a simplified illustration of an example GUI 900 showing a jog wheel UI element 136, in one or more embodiments. In one embodiment, the jog wheel UI element 136 may be overlaid at any position on GUI 900, with any elements of GUI 900 that may be present underneath the jog wheel UI element 136 being obscured by the jog wheel UI element 136. In another embodiment, at least a portion of one or more elements positioned underneath the jog wheel UI element 136 may be modified to accommodate the jog wheel UI element 136 above those elements and make it easier for a user to see and interact with the jog wheel UI element 136.

As shown in FIG. 9, the jog wheel UI element 136 is positioned on the left side of GUI 900 and is overlaid above a portion of the video player 120 and timeline 121. In this example GUI 900, portions 138 of the video player 120 and timeline 121 that are beneath the jog wheel UI element 136 are de-emphasized in some manner. For example, the portions 138 of elements beneath the jog wheel UI element 136 may be displayed with dashed lines, with lines and edges that are fainter relative to other portions of the elements, with blurred lines, with softened lines, etc. In this way, the user of GUI 900 can more easily identify the controls of the jog wheel UI element 136 without visual intrusion by elements beneath the jog wheel UI element 136.

According to an approach, lines and/or edges of the jog wheel UI element 136 may be emphasized relative to other elements of GUI 900 to aid the user in identifying controls of the jog wheel UI element 136.

In another embodiment, the jog wheel UI element 136 may have a certain amount of transparency that allows elements beneath the jog wheel UI element 136 to be partially visible and not totally obscured. This allows for easier identification of the jog wheel UI element and any elements associated therewith (e.g., a selection button, locking button, etc.).

According to another embodiment, the jog wheel UI element 136 may be completely opaque and completely obscure any portion of elements beneath the jog wheel UI element 136.

### Corner Placement of Jog Wheel UI Elements

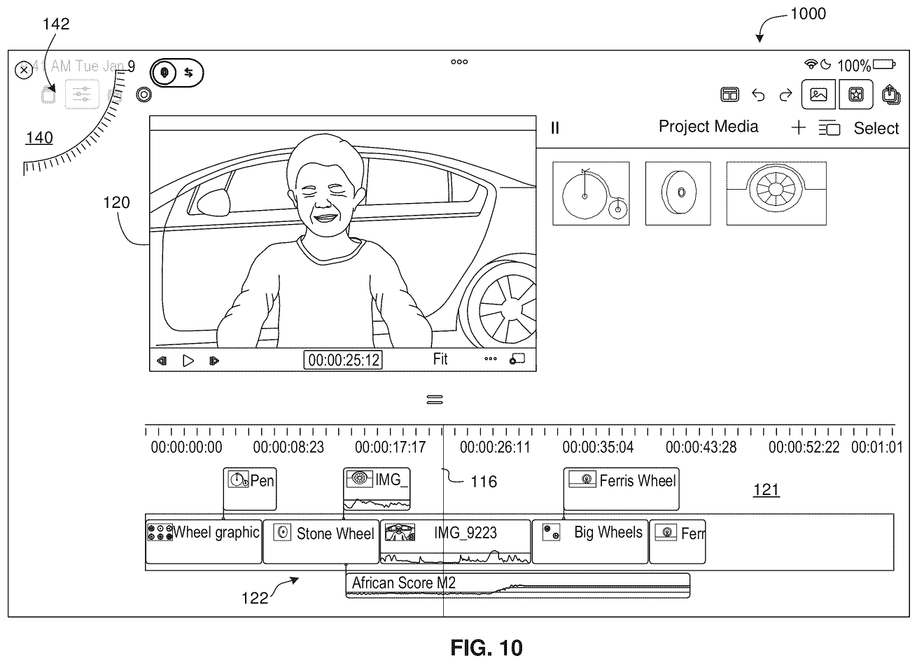

FIGS. 10-13 are simplified illustrations of example GUIs showing jog wheel UI elements in corners of the GUI, in one or more embodiments. FIG. 10 shows an example GUI 1000 having a corner jog wheel UI element 140 positioned in an upper left corner of GUI 1000. Moreover, in one or more embodiments, portions 142 of elements positioned beneath the corner jog wheel UI element 140 may be de-emphasized relative to other portions of the elements and/or the corner jog wheel UI element 140 may be emphasized relative to other elements of GUI 1000. In some embodiments, such an effect may be omitted.

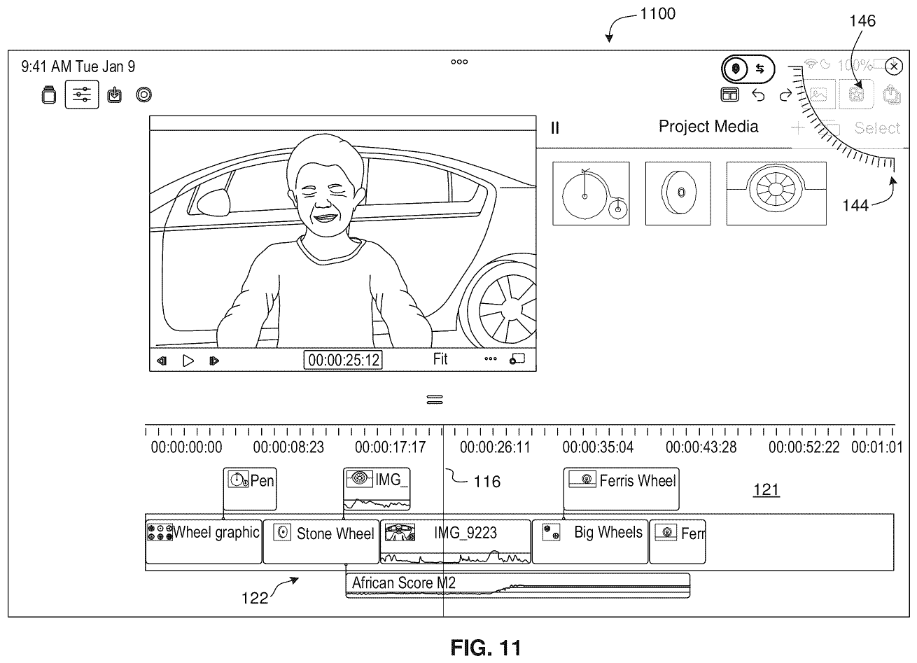

FIG. 11 shows an example GUI 1100 having a corner jog wheel UI element 144 positioned in an upper right corner of GUI 1100. Moreover, in one or more embodiments, portions 146 of elements positioned beneath the corner jog wheel UI element 144 may be de-emphasized relative to other portions of the elements and/or the corner jog wheel UI element 144 may be emphasized relative to other elements of GUI 1100. In some embodiments, such an effect may be omitted.

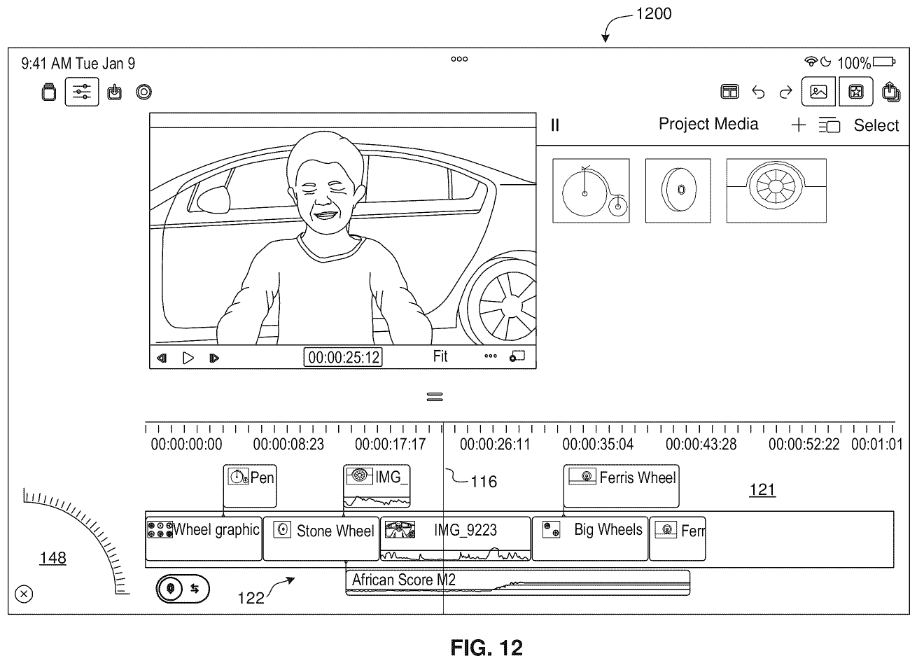

FIG. 12 shows an example GUI 1200 having a corner jog wheel UI element 148 positioned in a lower left corner of GUI 1200. Moreover, in one or more embodiments, portions of elements positioned beneath the corner jog wheel UI element 148 may be de-emphasized relative to other portions of the elements and/or the corner jog wheel UI element 148 may be emphasized relative to other elements of GUI 1200. However, in FIG. 12, no elements are positioned beneath the corner jog wheel UI element 148 to illustrate this effect. Moreover, such an effect may be omitted in this or any other embodiment.

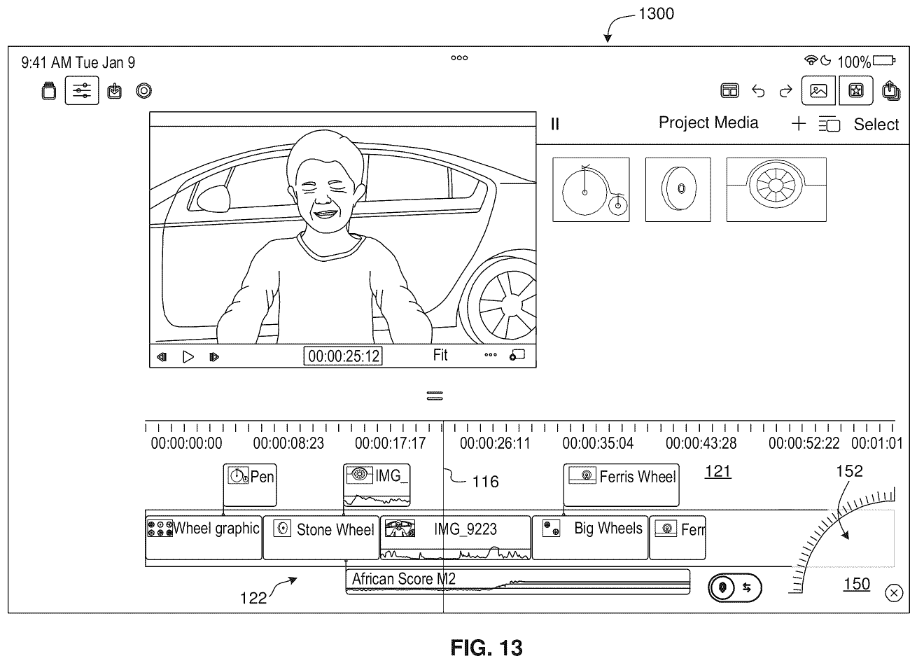

FIG. 13 shows an example GUI 1300 having a corner jog wheel UI element 150 positioned in a lower right corner of GUI 1300. Moreover, in one or more embodiments, portions 152 of elements positioned beneath the corner jog wheel UI element 150 may be de-emphasized relative to other portions of the elements and/or the corner jog wheel UI element 150 may be emphasized relative to other elements of GUI 1300. In some embodiments, such an effect may be omitted.

### Touch Input Position Relative to the Jog Wheel UI Element

The position of a touch input relative to a particular portion of the jog wheel UI element may be used to determine how to respond to the touch input, in one or more embodiments. Specifically, as the touch input moves farther from a point located upon the jog wheel UI element, the less rotation will be imparted to the jog wheel UI element for a same amount of rotational input provided by the touch input. In some embodiments, the point located upon the jog wheel UI element may be an axis of rotation for the jog wheel UI element. In an approach, the point located upon the jog wheel UI element may be an inner or outer edge of a farthest extent of the jog wheel. In various other embodiments, some other predetermined point associated with the jog wheel UI element may be used as the point of measurement to determine a distance of the touch input from the jog wheel UI element.

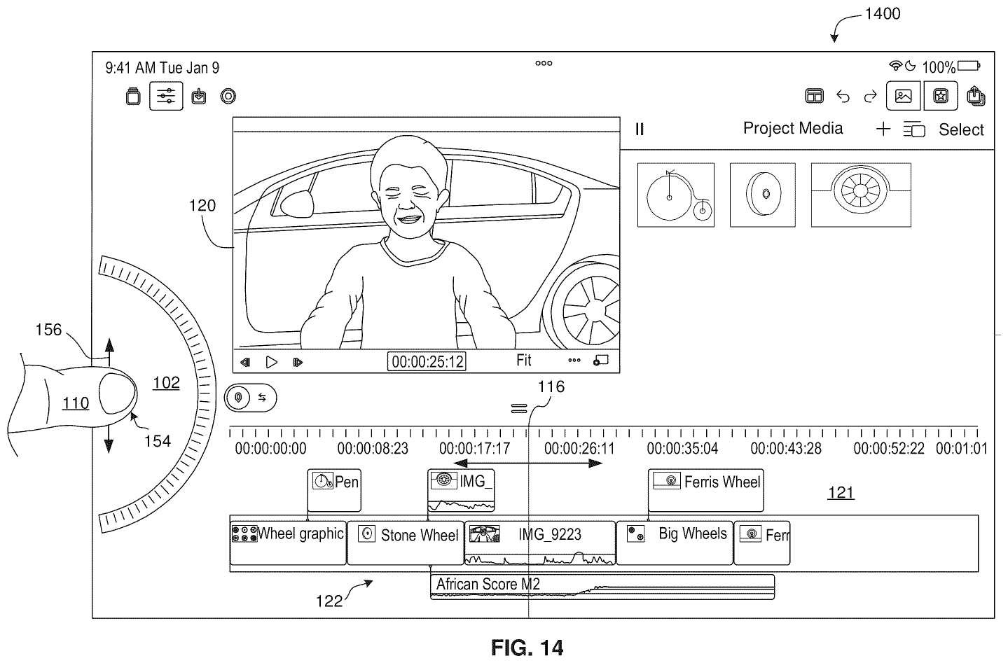

FIG. 14 is a simplified illustration of an example GUI 1400 showing a touch input 156 on a jog wheel UI element 102, in one or more embodiments. Touch input 156 may be upward/downward to rotate the jog wheel UI element 102 in a clockwise/counter-clockwise direction while concurrently moving the current position indicator 116 in a corresponding direction along timeline 121.

In some embodiments, touch input can be provided to the jog wheel UI element 102 at any location in a GUI, and the farther the input is from the jog wheel UI element 102, the less change will be imparted on a secondary element controlled by rotation of the jog wheel UI element 102. This is because, for a circular object like the jog wheel UI element 102, an amount of rotation gained from rotational input (which can be linear touch input or curved touch inputs imparted onto the jog wheel, as described herein) is inversely related to a distance of the rotational input from an axis of rotation. In other words, rotational input farther from the axis moves (rotates) the jog wheel less, while rotational input closer to the axis of rotation moves (rotates) the jog wheel more.

In FIG. 14, the position 154 of the touch input 156 is located upon the jog wheel UI element 102 near to a particular point of the jog wheel UI element 102 used to measure a distance to the touch input (such as an axis of rotation for the jog wheel UI element 102), and not toward an edge of the jog wheel UI element 102 or located entirely off of the jog wheel UI element. Because of this positioning of the touch input 156 close to the particular point of the jog wheel UI element 102 used to measure a distance to the touch input, the movement imparted on the current position indicator 116 is greater as compared to when the touch input is located on the edge of the jog wheel UI element 102 and/or off of the jog wheel UI element 102 farther away from the particular point of the jog wheel UI element 102. In some approaches, the touch input 156 may start close to the particular point of the jog wheel UI element 102 used to measure a distance to the touch input and then extend away from this particular point, in order to allow the user to start moving quickly and then refine the movement to be slower and slower the farther the touch input is moved away from the particular point of the jog wheel UI element 102 used to measure a distance to the touch input.

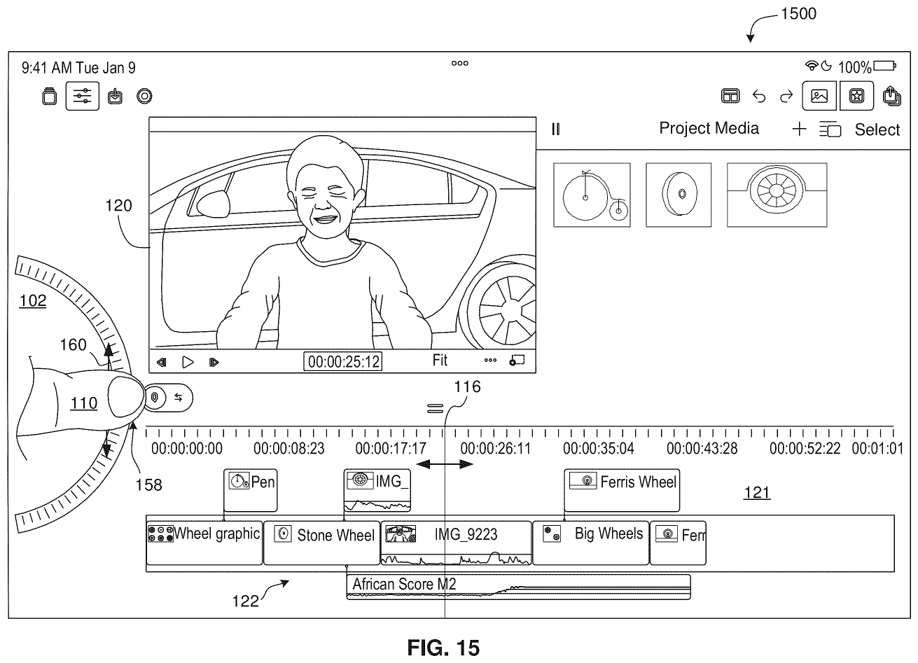

FIG. 15 is a simplified illustration of an example GUI showing a touch input on a jog wheel UI element in one or more embodiments.

FIG. 15 is a simplified illustration of an example GUI 1500 showing a touch input 160 for a jog wheel UI element 102, in one or more embodiments. Touch input 160 may be an upward/downward movement about the same distance as touch input 156 in FIG. 14. The touch input 160 may rotate the jog wheel UI element 102 in a clockwise/counter-clockwise direction while concurrently moving the current position indicator 116 in a corresponding direction along timeline 121 a distance that is less than the distance of movement imparted to the current position indicator 116 by the movement caused by touch input 156 in FIG. 14.

In FIG. 15, because the position 158 of the touch input 160 is located off an edge of the jog wheel UI element 102 farther away from the particular point of the jog wheel UI element 102 used to measure a distance to the touch input, the movement imparted on the current position indicator 116 is less than if the touch input was located closer to the particular point of the jog wheel UI element 102 used to measure a distance to the touch input. The touch input 160 may begin at a position other than that shown in FIG. 15 (such as upon the jog wheel UI element 102 itself) and then move out or in to the position shown in FIG. 15.

Moreover, in one or more embodiments, the jog wheel UI element 102 may be configured to exhibit inertia. A touch input (such as a fast swipe or flick) may start the jog wheel UI element 102 spinning at a rate of rotation that corresponds to a speed of the touch input (average speed, peak speed, final speed when contact ceases, etc.). Once the touch input ceases, the jog wheel UI element 102 may begin to slow, but will continue spinning for a period of time after the touch input has ceased, due to the perceived inertia of the jog wheel itself.

### Invoking and Positioning the Jog Wheel UI Element

The position of the jog wheel UI element may be selected by the user at any time. In one approach, the jog wheel UI element may be invoked and/or repositioned on the GUI using a touch input.

For example, to invoke the jog wheel UI element, a user may select and/or hover over a particular portion of the GUI, which may be designated by an icon, graphic, text, or some other identifying feature letting the user know that the jog wheel UI element will propagate from that location. Upon the user invoking the jog wheel UI element with a touch input at an invocation location, an animation of the jog wheel UI element may be displayed showing it being revealed from a side, top, or bottom of the GUI near the invocation location.

In another approach, the jog wheel UI element may appear at a predesignated position regardless of the invocation location. This may occur using the revealing animation or by displaying the jog wheel UI element without an animation.

In one embodiment, a user may touch at a designated position on or just off the GUI, and drag toward a middle of the GUI to reveal the jog wheel UI element. In this embodiment, if the user maintains touch input contact with the touchscreen, the jog wheel UI element may be interacted with by the user to receive input, respond to the input by manipulating some secondary element of the GUI. Upon release of the touch input by the user, the jog wheel UI element may hide from view. This automatic hiding function may have a delay, where the jog wheel UI element remains visible (and operable) on the GUI for a period of time after the continuous touch input is terminated, and then hides form view after the period of time. This allows the user some time to interact with the jog wheel UI element after performing a first action, without needing to re-invoke or reveal the jog wheel UI element each time the user wishes to use it.

Once the jog wheel UI element is displayed on the GUI, it may act like a floating element above the GUI, such that the user may move the jog wheel UI element to any position on the GUI as desired. This repositioning may be used to ensure the jog wheel UI element does not overlap content of the GUI that the user needs to see/interact with. As the jog wheel UI element is moved about the GUI, its appearance may change to account for its new position on the GUI.

In one example, movement of the jog wheel UI element from the left side to the right side will cause the jog wheel UI element to flip its appearance horizontally, and possibly reverse its response to touch input received via the jog wheel UI element.

In another example, movement of the jog wheel UI element from the top to the bottom of the GUI will cause the jog wheel UI element to flip its appearance vertically, and possibly reverse its response to touch input received via the jog wheel UI element.

Movement of the jog wheel UI element may be accomplished using a drag and drop input or any other touch input that can designate a new position for the jog wheel UI element.

In another approach, one or more predesignated positions and appearances for the via the jog wheel UI element may be designated, and the user may select from these positions when placing the via the jog wheel UI element on the GUI.

In an approach, the jog wheel UI element may overlay other content of the GUI, with various possible treatments for the overlaid content being possible, as discussed herein in several embodiments.

If the user attempts to move the jog wheel UI element to a position on the GUI that is undesirable and/or disallowed (e.g., due to content being in the position that is designated as not allowing overlay objects), the jog wheel UI element may snap back to an allowable position. In another approach, the jog wheel UI element may “bounce” from the disallowed position back to an allowed position. Moreover, audible and/or haptic feedback may be provided to the user indicating an issue with the desired position.

### Jog Wheel UI Element Appearance

The appearance of the jog wheel UI element may be selected and/or modified by the user at any time. In one approach, the jog wheel UI element appearance may be modified via a menu interface, with various options being presented to a user for selection thereof. In another embodiment, a selectable UI element associated with the jog wheel UI element may be touched (and possibly held) while manipulation of the jog wheel itself may cause selection of one of the various options pre-designated for the jog wheel UI element.

Some aspects of the jog wheel UI element that may be selected and/or modified may include, but are not limited to: a color of the jog wheel UI element, a size of the jog wheel UI element, a number of jog wheel UI elements displayed on the GUI, a transparency of the jog wheel UI element, an overlay characteristic of the jog wheel UI element, methods for revealing and hiding the jog wheel UI element, a portion of the jog wheel UI element to display on the GUI, etc.

In one embodiment, a touch and hold input may cause a size of the jog wheel UI element to increase and/or decrease. For example, touching, holding, and dragging the outer ring of the jog wheel UI element may allow the user to grow or shrink the jog wheel UI element intuitively.

In another embodiment, a multitouch input may be used to expand and/or contract the jog wheel UI element. For example, a pinch touch input may shrink or contract a size of the jog wheel UI element, while a spread or pinch-out touch input may expand or grow a size of the jog wheel UI element. Of course, these functions may be reversed relative to receiving the multitouch input (e.g., pinch to expand/grow, spread to shrink/contract).

### Example Processes

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

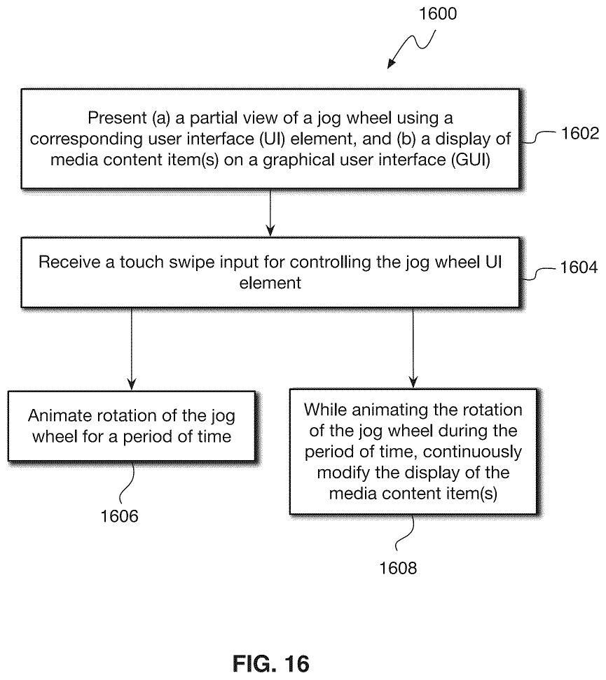

FIG. 16 is flow diagram of an example process 1600 for interacting with a GUI using a jog wheel UI element in one or more embodiments. More or less operations than those shown and described herein may be included in process 1600 in various approaches.

In operation 1602, a computing device displays a partial view of a jog wheel UI element on a GUI. The GUI is configured for display on a touchscreen display, in some embodiments. The jog wheel UI element may be displayed in response to a trigger, such as user input invoking the jog wheel UI element, an application or operating system requesting the jog wheel UI element, some condition of parameter being satisfied within an application or operating system of a computing device, etc. The jog wheel UI element is associated with display of one or more media content items, such as a catalog, list, thumbnail view arrangement, folder, etc., which shows, in a manner which can be understood by a user, the various media content items available for interaction, such as moving, copying, deleting, adding to a media presentation, sampling, etc.

In operation 1604, the computing device receives a touch swipe input for controlling the jog wheel UI element. The touch swipe input may be received via a touchscreen display in one embodiment. Moreover, the touchscreen display may be controlled by a tablet or pad computing device.

A touch swipe input may have one or more discernible characteristics that may be determined by the computing device upon receiving the touch input. The touch input characteristics may be used, at least in part, to determine a response to the touch swipe input in some embodiments. Some example characteristics include, but are not limited to, a distance between an initial contact point and a last contact point associated with the touch input (e.g., a length of the touch swipe input), an approximate direction of the touch input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a number of touch inputs received concurrently, a number of successive touch inputs received within a predetermined period of time (double tap, triple tap, etc.), a size of contact for the touch input (palm versus finger versus stylus), the use of a specialized touch device for configurable input (e.g., a touch stylus), etc.

In operation 1606, the computing device, responsive to the touch swipe input, animates a rotation of the jog wheel UI element based on the touch swipe input. Animating rotation of the jog wheel UI element may comprise spinning markings (e.g., tick marks) displayed upon the jog wheel UI element in a direction consistent with the touch input in one embodiment. In one approach, when an outer edge of the jog wheel UI element is not smooth, animating rotation of the jog wheel UI element may comprise moving the uneven edge of the jog wheel UI element in the direction consistent with the touch input.

In one or more embodiments, rotation of the jog wheel UI element includes: (a) rotating the jog wheel UI element at an initial rotational speed that is based on the touch swipe input, with the jog wheel UI element continuing to rotate subsequent to cessation of the touch swipe input due to a perceived inertia of the jog wheel UI element, and (b) subsequent to cessation of the touch swipe input, reducing a rotational speed of the jog wheel UI element until the rotational speed of the jog wheel UI element reaches zero. In other words, once the touch input is finished (e.g., the user raises the point of contact from the touchscreen display), the jog wheel UI element will continue spinning, but begin to slow down from the initial spinning rate until it comes to a stop.

In operation 1608, concurrently with animating the rotation of the jog wheel UI element, the computing device continuously modifies the display of at least one of the one or more media content items. A rate of modification for modifying the display of the at least one of the one or more media content items corresponds to the rotational speed of the jog wheel UI element. Therefore, as the jog wheel UI element begins to slow down after the touch input is finished, the modification for modifying the display of the at least one of the one or more media content items will begin to slow down until the rotation and modification both come to a stop at the same time.

According to one embodiment, a degree of the rotation of the jog wheel UI element, at least initially, may be proportional to a length of the touch swipe input.

Should another touch input be received on the jog wheel UI element prior to stopping rotation due to the first touch input, the jog wheel UI element will respond to the second touch input by rotating at an initial rotational speed that is based on the second touch swipe input. In one approach, the second touch input may be tempered by any residual rotation provided by the first touch input, particularly when the second touch input is in about an opposite direction as the first touch input.

In another embodiment, upon receiving the second touch input, the jog wheel UI element may cease spinning in the direction resultant from the first touch input just before beginning to spin in a direction and at an initial rate consistent with the second touch input.

The computing device may modify the one or more media content items in any perceivable way as a result of the touch swipe input to the jog wheel UI element. Some example modifications include, but are not limited to, a currently displayed media content item of the one or more media content items, an audio characteristic associated with the at least one of the one or more media content items, an image characteristic of at least one of the one or more media content items, etc.

By modifying the currently displayed media content item, a different media content item may be selected and displayed, e.g., in a video or image viewer within the GUI. In other words, the GUI transitions from displaying a first media content item (e.g., a video of a child playing soccer) of the one or more media content items to displaying a second media content item (e.g., a photograph of a trip to Hawaii) of the one or more media content items. Audio characteristics include any of maximum volume, minimum volume, relative volume levels, average loudness, root mean square (RMS) volume, etc. Image characteristics include any of a color, contrast, hue, brightness, filter(s) applied, cropping area, dimensions, aspect ratio, format, metadata, blur, etc.

In one or more embodiments, the computing device may determine an approximate direction of the touch swipe input. Based on the approximate direction of the touch input, the computing device may map the approximate direction of the touch swipe input to a clockwise rotation of the jog wheel UI element or a counter-clockwise rotation of the jog wheel UI element. In one example, a downward touch input upon a right side of a jog wheel UI element causes clockwise rotation and an upward touch input upon a right side of a jog wheel UI element causes counter-clockwise rotation. In another example, a downward touch input upon a left side of a jog wheel UI element causes counter-clockwise rotation and an upward touch input upon a left side of a jog wheel UI element causes clockwise rotation. According to another example, a leftward touch input upon a top side of a jog wheel UI element causes counter-clockwise rotation and a rightward touch input upon a top side of a jog wheel UI element causes clockwise rotation. In another example, a leftward touch input upon a bottom side of a jog wheel UI element causes clockwise rotation and a rightward touch input upon a bottom side of a jog wheel UI element causes counter-clockwise rotation.

In accordance with one or more embodiments, animating the rotation of the jog wheel UI element includes rotating at least a circular element of the jog wheel UI element in one of a clockwise direction or a counter-clockwise direction based on the mapping operation.

In one approach, the computing device may immediately stop the rotation of the jog wheel UI element when a stop flag (such as a bookmark, chapter divider, page break, section break, a keyword being searched for in text, etc.) associated with the one or more media content items is reached while modifying the display of the one or more media content items. In other words, as the jog wheel UI element is spinning to navigate through the various media content items, if a stop flag is present at some point within the media content items (either within a particular media content item or positioned between two media content items), the jog wheel UI element will immediately stop, and traversal of the various media content items will stop at the stop flag.

The rotational speed of the jog wheel UI element may be linearly reduced at a constant rate or at a declining rate (stopping more quickly as the speed of rotation is decreased) until the rotational speed of the jog wheel UI element reaches zero, resulting in a gradual stop of rotation in one approach.

The rotational speed of the jog wheel UI element may be reduced at a declining or decaying rate that is not linear until the rotational speed of the jog wheel UI element reaches zero in another approach, which results in the jog wheel UI element coming to an abrupt stop.

In one or more embodiments, rotation of the jog wheel UI element may cause audible indication of the rotation to be output. For example, concurrently with animating the rotation of the jog wheel UI element, the computing device may output audio clicks at a frequency that is proportional to the rotational speed of the jog wheel UI element. In other words, these audio clicks may be faster when the jog wheel is spinning faster, and the audio clicks may be slower when the jog wheel is spinning slower.

According to one embodiment, one or more characteristics of the jog wheel UI element may be adjustable. The adjustment may be made via a selectable element on GUI, a menu, a voice command, etc. The characteristics of the jog wheel UI element may include, but are not limited to: a color of the jog wheel UI element, a size of the jog wheel UI element, a position of the jog wheel UI element on the GUI, an input response direction of the jog wheel UI element, a sensitivity of the jog wheel UI element, a number of jog wheel UI elements displayed on the GUI, a transparency of the jog wheel UI element, an overlay characteristic of the jog wheel UI element, inertia of the jog wheel UI element, methods for revealing and hiding the jog wheel UI element, a portion of the jog wheel UI element to display on the GUI, etc.

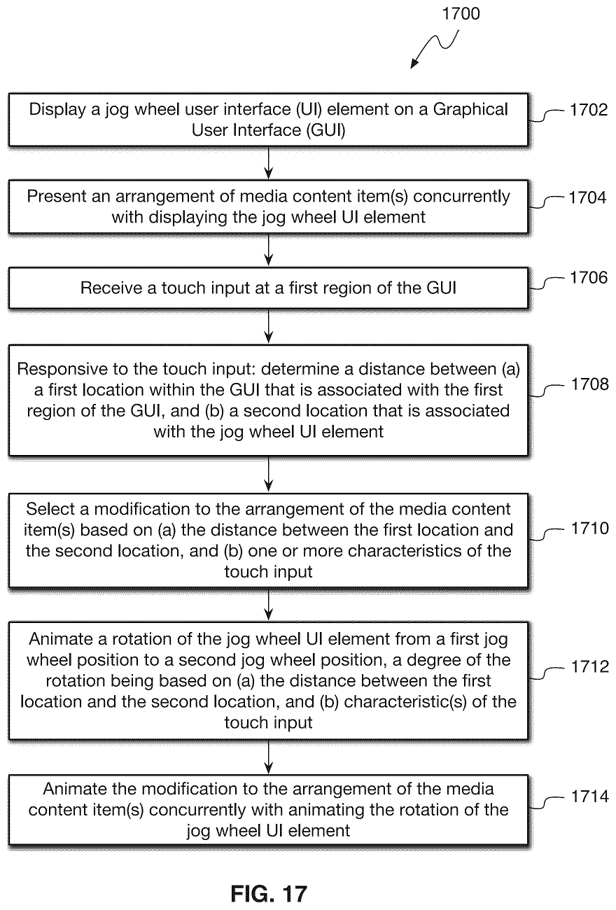

FIG. 17 is flow diagram of an example process 1700 for interacting with a GUI using a jog wheel UI element in one or more embodiments. More or less operations than those shown and described herein may be included in process 1700 in various approaches.

In operation 1702, a computing device displays a jog wheel UI element on a GUI. The GUI may be displayed on a touchscreen display in one embodiment.

In operation 1704, the computing device presents an arrangement of one or more media content items concurrently with displaying the jog wheel UI element. The media content items may include videos, images, audio clips, animation, transitions, etc.

In operation 1706, the computing device receives a touch input at a first region of the GUI. The touch input may be received via a touchscreen display in one embodiment. Moreover, the touchscreen display may be controlled by a tablet or pad computing device.

A touch input may have one or more discernible characteristics that may be determined by the computing device upon receiving the touch input. The touch input characteristics may be used, at least in part, to determine a response to the touch input in some embodiments. Some example characteristics include, but are not limited to, a distance between an initial contact point and a last contact point associated with a touch swipe input (e.g., a length of the touch swipe input), an approximate direction of the touch swipe input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a number of touch inputs received concurrently, a number of successive touch inputs received within a predetermined period of time (double tap, triple tap, etc.), a size of contact for the touch input (palm versus finger versus stylus), the use of a specialized touch device for configurable input (e.g., a touch stylus), etc.

In operation 1708, responsive to the touch input, the computing device determines a distance between: (a) a first location within the GUI that is associated with the first region of the GUI (e.g., a point where a tap touch input was detected, an average placement of a swipe touch input, a closest point in a swipe touch input, a farthest point in a touch swipe input, etc.), and (b) a second location that is associated with the jog wheel UI element (e.g., the axis of rotation or some other predesignated point on or near the jog wheel UI element).

In one embodiment, the second location may be associated with and/or set as a particular tick mark displayed near an edge of the jog wheel UI element, and/or may be a closest portion of the jog wheel to the location of the touch input.

Upon determining this distance, in operation 1710 the computing device selects a modification to the arrangement of the one or more media content items. The modification may be based on, in one approach: a) the distance between the first location and the second location, and b) one or more characteristics of the touch input.

A touch input may have one or more discernible characteristics that may be used, at least in part, to determine a response to the touch input, in some embodiments. Some example characteristics include, but are not limited to, a distance between an initial contact point and a last contact point associated with the touch input (e.g., a length of the touch swipe input), an approximate direction of the touch input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a region, portion, and/or elements of the GUI that are visually displayed where the touch input is detected, etc.

Modification of the one or more media content items may include any change in appearance, position, content, inclusion, exclusion, or other aspect of the media content items displayed to the GUI (including modifying a media content item hidden from view of the GUI, at least until performance of the modification). Some example modifications include, but are not limited to: moving and/or positioning a media content item relative to other elements and/or media content items displayed on the GUI, deleting a media content item from a set of media content items, adding a media content item to a set of media content items, repositioning a media content item on a timeline relative to other media content items thereon, revealing properties and/or info about a media content item, changing a size (enlarging/shrinking) for displaying at least one media content item relative to other elements displayed on the GUI, swapping one media content item for another, duplicating a media content item, clipping a media content item, expanding a media content item, concurrently changing a volume for one or media content items, concurrently changing an image property of one or more media content items, displaying one or more individual tracks (audio, video, background, etc.) of a media content item, etc.

In operation 1712, the computing device animates a rotation of the jog wheel UI element such that it spins from a first jog wheel position to a second jog wheel position. A degree of the rotation for the jog wheel UI element may be based on: a) the distance between the first location and the second location, and b) the one or more characteristics of the touch input. In other words, the distance between the touchscreen contact point and the jog wheel UI element is used to determine how much rotation to impart on the jog wheel UI element. In one approach, the farther the distance is between the touchscreen contact point and the jog wheel UI element, the less amount of rotation is imparted to the jog wheel. Conversely, the shorter the distance is between the touchscreen contact point and the jog wheel UI element, the more amount of rotation is imparted to the jog wheel.

In one approach, the computing device detects a length of a swiping motion of the touch input to determine the degree of the rotation of the jog wheel UI element, which is proportional to the length of the swiping motion.

According to one or more embodiments, for a same particular length of the swiping motion, the degree of the rotation of the jog wheel UI element increases proportional to the particular length of the swiping motion as the distance between the first location and the second location is decreased.

In some embodiments, for a same particular length of the swiping motion, the degree of the rotation of the jog wheel UI element decreases proportional to the particular length of the swiping motion as the distance between the first location and the second location is increased.

In operation 1714, concurrently with animating the rotation of the jog wheel UI element from the first jog wheel position to the second jog wheel position, the computing device animates the modification to the arrangement of the one or more media content items.

According to one embodiment, one or more characteristics of the jog wheel UI element may be adjustable. The adjustment may be made via a selectable element on GUI, a menu, a voice command, etc. The characteristics of the jog wheel UI element may include, but are not limited to: a color of the jog wheel UI element, a size of the jog wheel UI element, a position of the jog wheel UI element on the GUI, an input response direction of the jog wheel UI element, a sensitivity of the jog wheel UI element, a number of jog wheel UI elements displayed on the GUI, a transparency of the jog wheel UI element, an overlay characteristic of the jog wheel UI element, inertia of the jog wheel UI element, methods for revealing and hiding the jog wheel UI element, a portion of the jog wheel UI element to display on the GUI, etc.

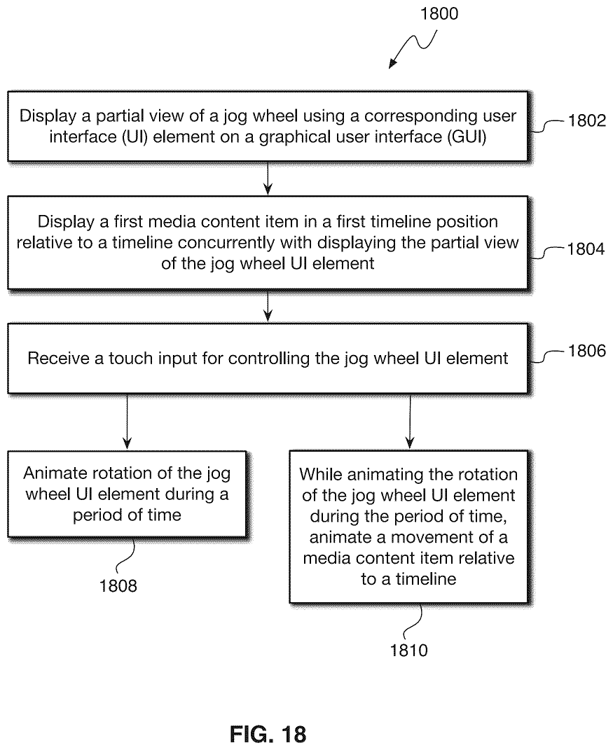

FIG. 18 is flow diagram of an example process 1800 for interacting with a GUI using a jog wheel UI element in one or more embodiments. More or less operations than those shown and described herein may be included in process 1800 in various approaches.

In operation 1802, a computing device displays at least a partial view of a jog wheel UI element on a GUI. The partial view may be a portion of about a circular UI element, such as 30°, 45°, 90°, 180°, 270°, 360°, or some other portion of the circular UI element for receiving touch input and controlling at least one secondary element on the GUI.

In operation 1804, the computing device displays a first media content item in a first timeline position relative to a timeline concurrently with displaying the partial view of the jog wheel UI element. In this way, the timeline, the media content item positioned on the timeline, and the jog wheel UI element are all displayed on the GUI at the same time. This allows a user to interact with the jog wheel UI element to control some aspect of the media content item, the timeline, and/or other media content items displayed on the timeline or available for display upon the timeline, in various approaches.

In one or more embodiments, the timeline may be similar in appearance and/or function as the timeline 121 shown and described in FIGS. 1-15.

Referring again to FIG. 18, in operation 1806, the computing device receives a touch input for controlling the jog wheel UI element. The touch input may be received via a touchscreen display in one embodiment. Moreover, the touchscreen display may be controlled by a tablet or pad computing device.

A touch input may have one or more discernible characteristics that may be determined by the computing device upon receiving the touch input. The touch input characteristics may be used, at least in part, to determine a response to the touch input in some embodiments. Some example characteristics include, but are not limited to, a distance between an initial contact point and a last contact point associated with a touch swipe input (e.g., a length of the touch swipe input), an approximate direction of the touch swipe input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a region, portion, and/or elements of the GUI that are visually displayed where the touch input is detected, a number of touch inputs received concurrently, a number of successive touch inputs received within a predetermined period of time (double tap, triple tap, etc.), a size of contact for the touch input (palm versus finger versus stylus), the use of a specialized touch device for configurable input (e.g., a touch stylus), etc.

In operation 1808, the computing device, responsive to the touch input, animates a rotation of the jog wheel UI element from a first jog wheel position to a second jog wheel position. The rotation is based, at least in part, on the touch input.

In operation 1810, the computing device animates a movement of the first media content item relative to the timeline from the first timeline position to a second timeline position concurrently with animating the rotation of the jog wheel UI element from the first jog wheel position to the second jog wheel position.

In one embodiment, a difference between the first timeline position and the second timeline position corresponds to a difference between the first jog wheel position and the second jog wheel position. In other words, the amount of rotation of the jog wheel dictates how far the media content item is temporally moved along the timeline. Other factors may be considered in determining how far to move the media content item, such as a distance of the touch input from a particular point of the jog wheel UI element, a pressure of the touch input, a speed of movement of the touch input, etc.

In one embodiment, a harder pressure touch input may move the media content item upon the timeline farther than a lighter pressure touch input. In another embodiment, a lighter pressure touch input may move the media content item upon the timeline farther than a harder pressure touch input.

In one embodiment, a touch swipe input at a higher speed may move the media content item upon the timeline farther than a slower speed touch swipe input.

According to one embodiment, when the difference between the first jog wheel position and the second jog wheel position is greater or increases during the touch input, the movement of the media content item upon the timeline will be greater (e.g., the difference between the first timeline position and the second timeline position is greater) as compared to when the difference between the first jog wheel position and the second jog wheel position is smaller, which causes a smaller movement of the media content item upon the timeline (e.g., the difference between the first timeline position and the second timeline position is less).

In an alternate embodiment, a smaller difference between the first jog wheel position and the second jog wheel position causes a greater difference between the first timeline position and the second timeline position, while a greater difference between the first jog wheel position and the second jog wheel position causes a smaller difference between the first timeline position and the second timeline position.

According to one embodiment, responsive to the movement of the first media content item to the second timeline position, the computing device may detect a second media content item located along the timeline that is positioned, at least partially between the first timeline position to the second timeline position. This includes situations where only a portion and/or all of the second media content item is positioned where the first media content item is to be moved (e.g., between the first timeline position and the second timeline position). In these situations, the computing device moves the second media content item along the timeline in a same direction as the movement of the first media content item. In other words, the computing device pushes all other media content items that are contacted by the first media contact item upon moving it along the timeline. The other media content items are pushed in a same direction and a same distance as the first media content item after initial contact is made by the first media content item.

In an embodiment, the computing device, responsive to the movement of the first media content item to the second timeline position, detects a second media content item located along the timeline at least partially between the first timeline position to the second timeline position. In this situation, the computing device clips a portion of the second media content item that would be overlapped due to the movement of the first media content item to the second timeline position. In a further embodiment, the computing device may overwrite, with a portion of the first media content item, the portion of the second media content item that would be overlapped due to the movement of the first media content item to the second timeline position. In another embodiment, the overlapped portion of the second media content item may be retained, and the second media content item may be moved to another lane of the timeline to allow the overlapping portion to be visually recognized by the user.

In one embodiment, the computing device, responsive to the movement of the first media content item to the second timeline position, detects a second media content item located along the timeline at least partially between the first timeline position to the second timeline position. In this situation, the computing device visibly reverses (moves in an opposite direction after moving in the first direction toward the second media content item) at least a portion of the movement of the first media content item to a third position along the timeline. The computing device determines where the third position is to be located in order to position the first media content item adjacent the second media content item. This avoids overlapping the first media content item with the second media content item. In other words, if a user attempts to move the first media content item to a position already occupied upon the timeline, an animation of the first media content item “bouncing” back from the attempted position to a permissible position (which is as far toward the second media content item as possible, e.g., adjacent and abutting the second media content item).

In an embodiment, the difference between the first timeline position and the second timeline position may be proportional to the difference between the first jog wheel position and the second jog wheel position. This proportional relationship may be 1:1, 1:2, 2:1, or some other ratio or multiplier that translates the degree of rotation of the jog wheel to movement of the first media content item along the timeline.

In a specific embodiment, the portion of the jog wheel UI element may be displayed left of center on the GUI and the timeline may be displayed horizontally with time increasing rightward (as in FIG. 1). In this embodiment, an approximately downward swipe touch input (straight down, down and leftward, down and rightward) may cause rightward movement of the first media content item relative to the timeline, while an approximately upward swipe touch input (straight up, up and leftward, up and rightward) causes leftward movement of the first media content item relative to the timeline.

In another specific embodiment, the portion of the jog wheel UI element may be displayed left of center on the GUI and the timeline may be displayed horizontally with time increasing rightward (as in FIG. 1). In this embodiment, an approximately downward swipe touch input (straight down, down and leftward, down and rightward) may cause leftward movement of the first media content item relative to the timeline, while an approximately upward swipe touch input (straight up, up and leftward, up and rightward) causes rightward movement of the first media content item relative to the timeline.

According to a specific embodiment, the portion of the jog wheel UI element may be displayed right of center on the GUI and the timeline may be displayed horizontally with time increasing rightward. In this embodiment, an approximately downward swipe touch input (straight down, down and leftward, down and rightward) may cause rightward movement of the first media content item relative to the timeline, while an approximately upward swipe touch input (straight up, up and leftward, up and rightward) causes leftward movement of the first media content item relative to the timeline.

According to another specific embodiment, the portion of the jog wheel UI element may be displayed right of center on the GUI and the timeline may be displayed horizontally with time increasing rightward. In this embodiment, an approximately downward swipe touch input (straight down, down and leftward, down and rightward) may cause leftward movement of the first media content item relative to the timeline, while an approximately upward swipe touch input (straight up, up and leftward, up and rightward) causes rightward movement of the first media content item relative to the timeline.

Prior to receiving the touch input for controlling the jog wheel UI element, the computing device may receive a first user input positioning the jog wheel UI element to a first location on the GUI. This first user input may be a drag and drop input, a first tap-move-second tap operation, selection of a menu item, selection of UI element on the GUI configured to allow movement of the jog wheel UI element, etc. Responsive to the first user input, the computing device configures the jog wheel UI element to respond to subsequent touch inputs based on the first location (and/or one or more characteristics of the subsequent touch input). This configuration may account for movement of the jog wheel UI element from one side of the GUI to another side which would reverse the input gestures (e.g., for interaction with a different thumb or finger). In further approaches, a size of the jog wheel UI element may be accounted for in this configuration, such that a user can intuitively interact with the jog wheel and the resultant effect of a secondary element of the GUI will be anticipated by the user.

In an embodiment, one or more characteristics of the jog wheel UI element may be user adjustable, via interaction with the GUI or some other input to the computing device. Some example characteristics of the jog wheel UI element include, but are not limited to, a color of the jog wheel UI element, a size of the jog wheel UI element, a position of the jog wheel UI element on the GUI, an input response direction of the jog wheel UI element, a sensitivity of the jog wheel UI element, a number of jog wheel UI elements displayed on the GUI, a transparency of the jog wheel UI element, an overlay characteristic of the jog wheel UI element, inertia of the jog wheel UI element, methods for revealing and hiding the jog wheel UI element, and a portion of the jog wheel UI element to display on the GUI, etc.

In one or more embodiments, rotation of the jog wheel UI element may cause audible indication of the rotation to be output. For example, concurrently with animating the rotation of the jog wheel UI element, the computing device may output audio clicks at a frequency that is proportional to the rotational speed of the jog wheel UI element. In other words, these audio clicks may be faster when the jog wheel is spinning faster, and the audio clicks may be slower when the jog wheel is spinning slower. The particular sound and volume level may be user selectable.

In another embodiment, haptic feedback may be provided through the computing device that is proportional to the rotational speed of the jog wheel UI element.

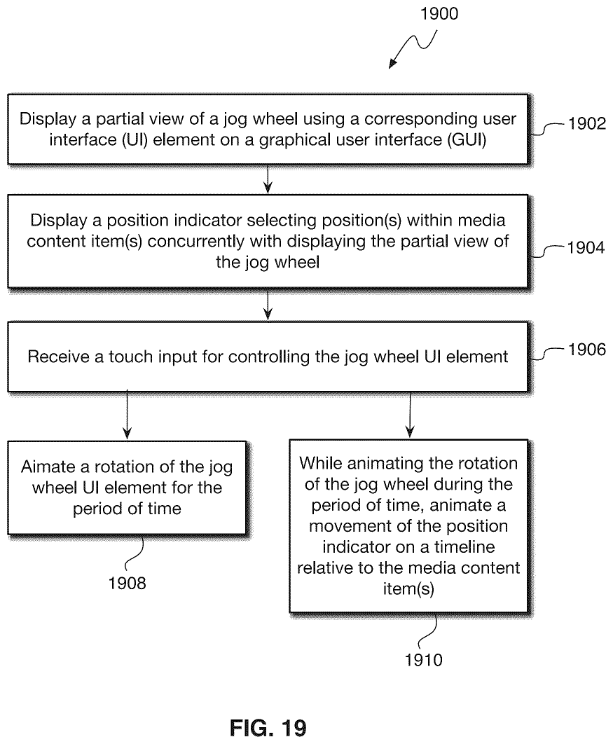

FIG. 19 is flow diagram of an example process 1900 for interacting with a GUI using a jog wheel UI element in one or more embodiments. More or less operations than those shown and described herein may be included in process 1900 in various approaches.

In operation 1902, a computing device displays at least a partial view of a jog wheel UI element on a GUI. The partial view may be a portion of about a circular UI element, such as 30°, 45°, 90°, 180°, 270°, 360°, or some other portion of the circular UI element for receiving touch input and controlling at least one secondary element on the GUI.

In operation 1904, the computing device displays a position indicator for selecting positions within one or more media content items concurrently with displaying the partial view of the jog wheel UI element. In this way, the timeline, the media content item positioned on the timeline, and the jog wheel UI element are all displayed on the GUI at the same time. This allows a user to interact with the jog wheel UI element to control some aspect of the media content item, the timeline, and/or other media content items displayed on the timeline or available for display upon the timeline, in various approaches.

In one or more embodiments, the timeline may be similar in appearance and/or function as the timeline 121 shown and described in FIGS. 1-15.

Referring again to FIG. 19, in operation 1906, the computing device receives a touch input for controlling the jog wheel UI element. The touch input may be received via a touchscreen display in one embodiment. Moreover, the touchscreen display may be controlled by a tablet or pad computing device.

A touch input may have one or more discernible characteristics that may be determined by the computing device upon receiving the touch input. The touch input characteristics may be used, at least in part, to determine a response to the touch input in some embodiments. Some example characteristics include, but are not limited to, a distance between an initial contact point and a last contact point associated with a touch swipe input (e.g., a length of the touch swipe input), an approximate direction of the touch swipe input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a region, portion, and/or elements of the GUI that are visually displayed where the touch input is detected, a number of touch inputs received concurrently, a number of successive touch inputs received within a predetermined period of time (double tap, triple tap, etc.), a size of contact for the touch input (palm versus finger versus stylus), the use of a specialized touch device for configurable input (e.g., a touch stylus), etc.

In operation 1908, the computing device, responsive to the touch input, animates a rotation of the jog wheel UI element from a first jog wheel position to a second jog wheel position. The rotation is based, at least in part, on the touch input. In an example, a longer touch input causes relatively greater rotation of the jog wheel UI element, while a shorter touch input causes relatively less rotation of the jog wheel UI element.

In operation 1910, the computing device, concurrently with animating the rotation of the jog wheel UI element from the first jog wheel position to the second jog wheel position, animates a movement of the position indicator on the timeline relative to any other media content items displayed along the timeline, the movement being from a first clip position to a second clip position.

In several approaches, a difference between the first clip position and the second clip position corresponds to a difference between the first jog wheel position and the second jog wheel position, e.g., greater rotation of the jog wheel translates to greater movement of the current position indicator.

In one embodiment, the computing device may receive a second touch input (via the GUI, the jog wheel UI element, and/or an element thereof), and responsive to receiving the second touch input, the computing device may clip a portion of at least one media content item positioned along the timeline at the current position indicator corresponding to the second clip position.

In a further embodiment, the portion of the one or more media content items may be clipped by moving at least one adjacent media content item in a direction of contraction (toward the portion of the one or media content items that is being removed by the clipping operation) of the one or more media content items relative to the timeline.

In an alternate embodiment, the portion of the one or more media content items may be clipped by expanding a portion of at least one adjacent media content item to add additional media content in a direction of contraction of the one or more media content items relative to the timeline.

In one embodiment, the computing device may receive a second touch input (via the GUI, the jog wheel UI element, and/or an element thereof), and responsive to receiving the second touch input, the computing device may expand the one or more media content items to add additional media content of the one or more media content items from a position along the timeline at the current position indicator corresponding to the second clip position.

In a further embodiment, the computing device may expand the one or more media content items by moving at least one adjacent media content item in a direction of expansion of the one or more media content items relative to the timeline.

In an alternate embodiment, the computing device may expand the one or more media content items by overwriting a portion of at least one adjacent media content item in a direction of expansion of the one or more media content items relative to the timeline.

In various embodiments, the rotation of the jog wheel UI element from the first jog wheel position to the second jog wheel position based on the touch input may cause the movement of the position indicator on the timeline to increment on a frame-by-frame basis, thereby allowing a user to increment through a video being displayed on a video player one frame at a time for precise video editing operations.

In more embodiments, the rotation of the jog wheel UI element from the first jog wheel position to the second jog wheel position based on the touch input may cause the movement of the position indicator on the timeline to increment on a subframe basis, thereby allowing a user to increment through a video being displayed on a video player one sub-frame of a single frame at a time for even more precise video editing operations and the ability to manipulate a single frame of a video to add/remove/change content thereof or associated with the video frame (e.g., one or more audio tracks that correspond to the frame being manipulated).

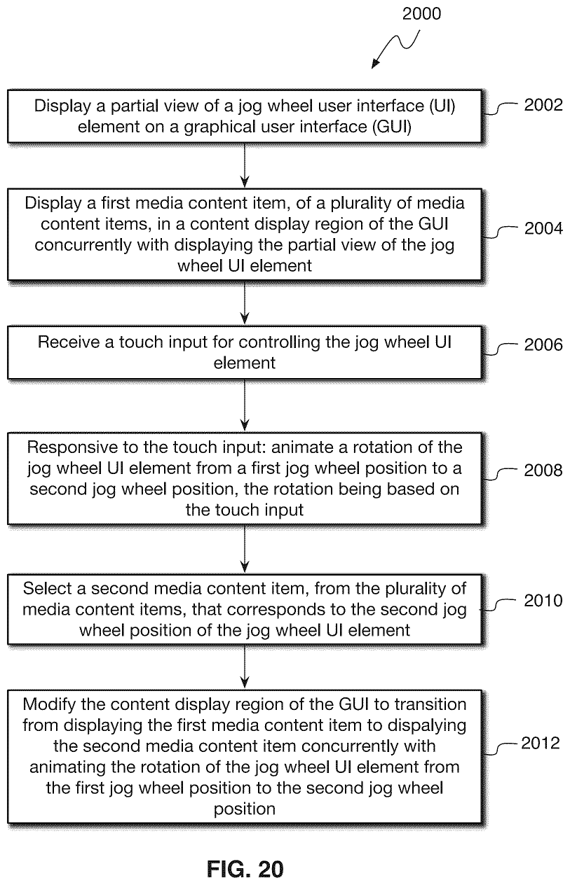

FIG. 20 is flow diagram of an example process 2000 for interacting with a GUI using a jog wheel UI element in one or more embodiments. More or less operations than those shown and described herein may be included in process 2000 in various approaches.

In operation 2002, a computing device displays at least a partial view of a jog wheel UI element on a GUI. The partial view may be a portion of about a circular UI element, such as 30°, 45°, 90°, 180°, 270°, 360°, or some other portion of the circular UI element for receiving touch input and controlling at least one secondary element on the GUI.

In operation 2004, the computing device displays a first media content item, of a plurality of media content items, in a content display region of the GUI concurrently with displaying the partial view of the jog wheel UI element. In this way, available media content items in the content display region of the GUI and the jog wheel UI element are displayed on the GUI at the same time. This allows a user to interact with the jog wheel UI element to control some aspect of the media content items, in various approaches.

In operation 2006, the computing device receives a touch input for controlling the jog wheel UI element. The touch input may be received via a touchscreen display in one embodiment. Moreover, the touchscreen display may be controlled by a tablet or pad computing device.

A touch input may have one or more discernible characteristics that may be determined by the computing device upon receiving the touch input. The touch input characteristics may be used, at least in part, to determine a response to the touch input in some embodiments. Some example characteristics include, but are not limited to, a distance between an initial contact point and a last contact point associated with a touch swipe input (e.g., a length of the touch swipe input), an approximate direction of the touch swipe input (e.g., horizontal, vertical, left, right, up, down, or a combination of directions that may be combined into a vector representation having two directional constituents), a pressure of the touch input (measurable by a touchscreen display capable of detecting touch pressure thereon), a speed of movement of the touch input, a region, portion, and/or elements of the GUI that are visually displayed where the touch input is detected, a number of touch inputs received concurrently, a number of successive touch inputs received within a predetermined period of time (double tap, triple tap, etc.), a size of contact for the touch input (palm versus finger versus stylus), the use of a specialized touch device for configurable input (e.g., a touch stylus), etc.

In operation 2008, the computing device, responsive to the touch input, animates a rotation of the jog wheel UI element from a first jog wheel position to a second jog wheel position. The rotation is based, at least in part, on the touch input. In an example, a longer touch input causes relatively greater rotation of the jog wheel UI element, while a shorter touch input causes relatively less rotation of the jog wheel UI element.

In operation 2010, the computing device selects a second media content item, from the plurality of media content items, that corresponds to the second jog wheel position of the jog wheel UI element. In other words, rotation of the jog wheel UI element causes a current media content item that is selected to change from one media content item to another media content item. The number of media content items that are traversed during the rotation of the jog wheel UI element may be proportional to the degree of rotation of the jog wheel UI element.

In operation 2012, the computing device modifies the content display region of the GUI to transition from displaying the first media content item to displaying the second media content item concurrently with animating the rotation of the jog wheel UI element from the first jog wheel position to the second jog wheel position.

Media content items may be displayed in a media content player portion of the GUI (similar to video player 120 shown in FIG. 3). In this way, the particular media content that is displayed in the media content player portion may be selected using the jog wheel UI element without needing to actively search and navigate through the available media content items using a series of touch inputs (such as through a menu interface, in a directory, on a thumbnail display view, in a gallery view, etc.).

Prior to receiving the touch input for controlling the jog wheel UI element, the computing device may receive a first user input positioning the jog wheel UI element to a first location on the GUI. This first user input may be a drag and drop input, a first tap-move-second tap operation, selection of a menu item, selection of UI element on the GUI configured to allow movement of the jog wheel UI element, etc. Responsive to the first user input, the computing device configures the jog wheel UI element to respond to subsequent touch inputs based on the first location (and/or one or more characteristics of the subsequent touch input). This configuration may account for movement of the jog wheel UI element from one side of the GUI to another side which would reverse the input gestures (e.g., for interaction with a different thumb or finger). In further approaches, a size of the jog wheel UI element may be accounted for in this configuration, such that a user can intuitively interact with the jog wheel and the resultant effect of a secondary element of the GUI will be anticipated by the user.

In an embodiment, one or more characteristics of the jog wheel UI element may be user adjustable, via interaction with the GUI or some other input to the computing device. Some example characteristics of the jog wheel UI element include, but are not limited to, a color of the jog wheel UI element, a size of the jog wheel UI element, a position of the jog wheel UI element on the GUI, an input response direction of the jog wheel UI element, a sensitivity of the jog wheel UI element, a number of jog wheel UI elements displayed on the GUI, a transparency of the jog wheel UI element, an overlay characteristic of the jog wheel UI element, inertia of the jog wheel UI element, methods for revealing and hiding the jog wheel UI element, and a portion of the jog wheel UI element to display on the GUI, etc.

In one or more embodiments, rotation of the jog wheel UI element may cause audible indication of the rotation to be output. For example, concurrently with animating the rotation of the jog wheel UI element, the computing device may output audio clicks at a frequency that is proportional to the rotational speed of the jog wheel UI element. In other words, these audio clicks may be faster when the jog wheel is spinning faster, and the audio clicks may be slower when the jog wheel is spinning slower. The particular sound and volume level may be user selectable.

In another embodiment, haptic feedback may be provided through the computing device that is proportional to the rotational speed of the jog wheel UI element.

### User Interface Elements

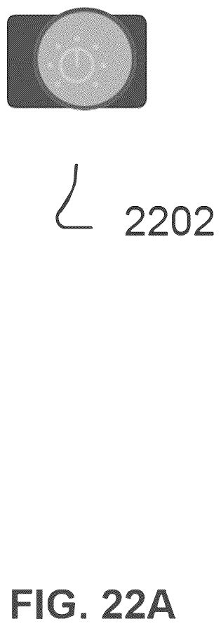

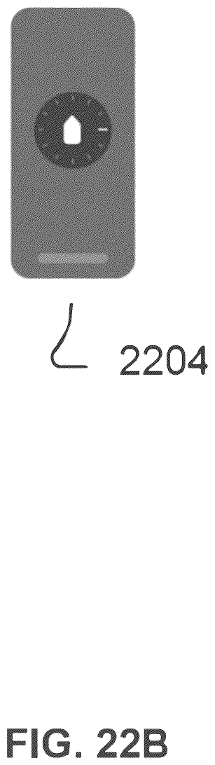

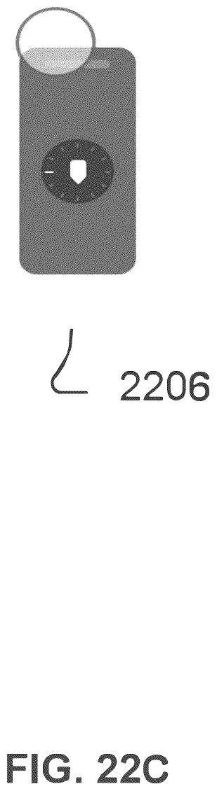

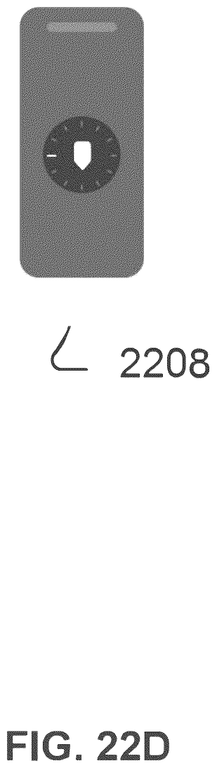

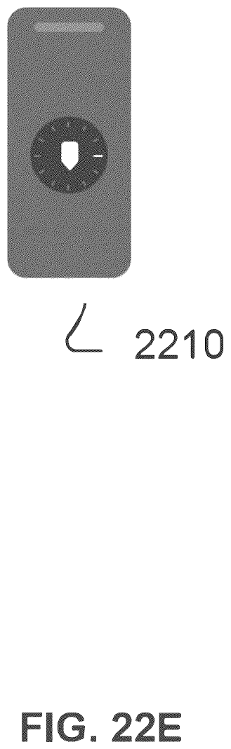

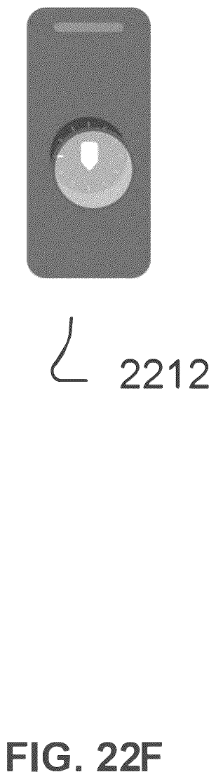

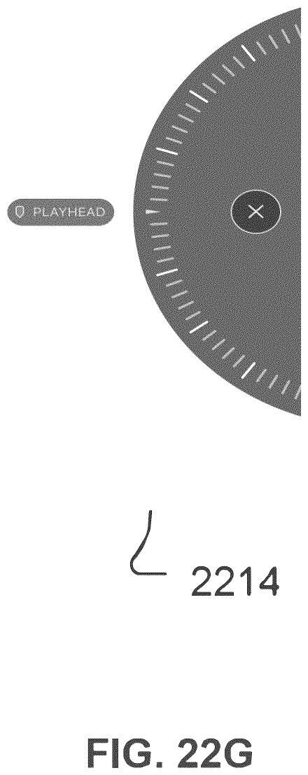

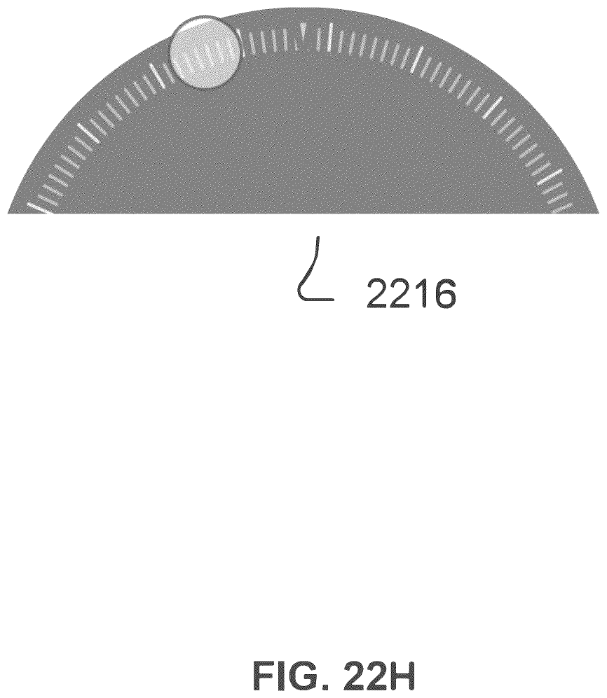

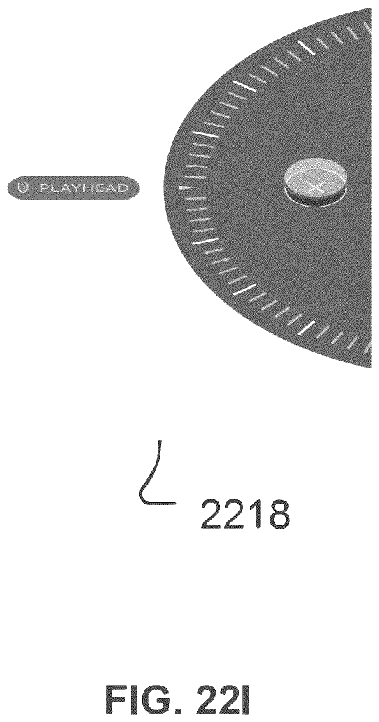

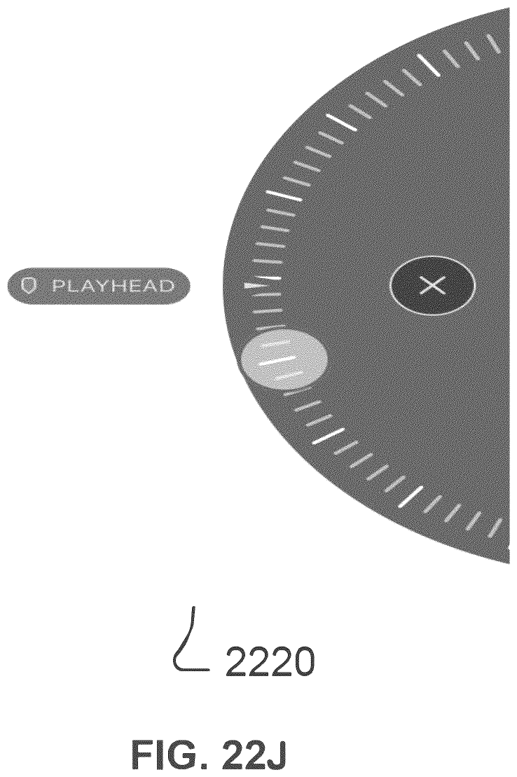

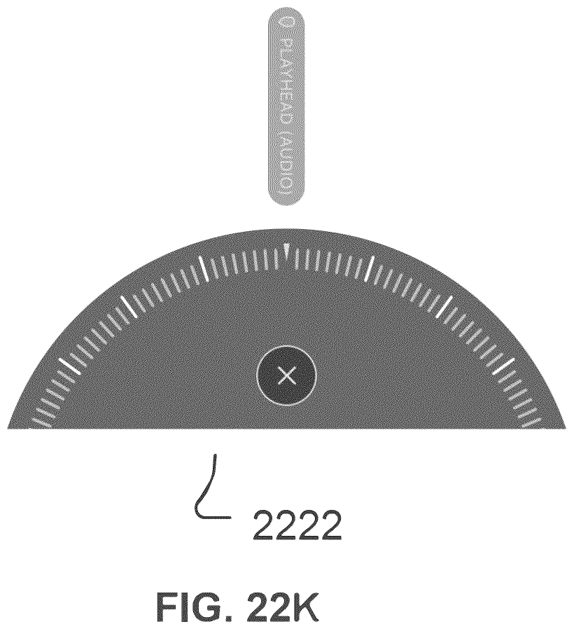

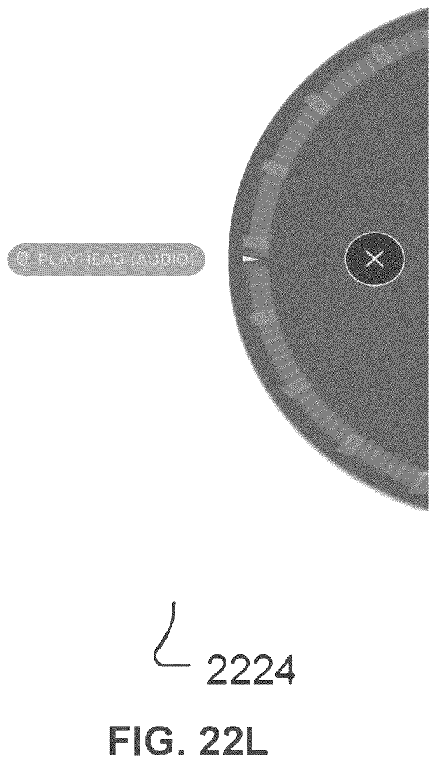

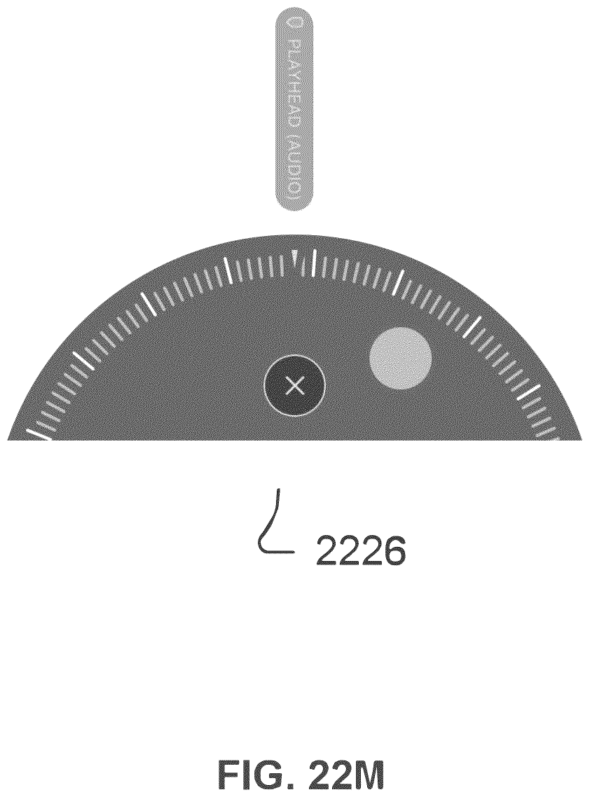

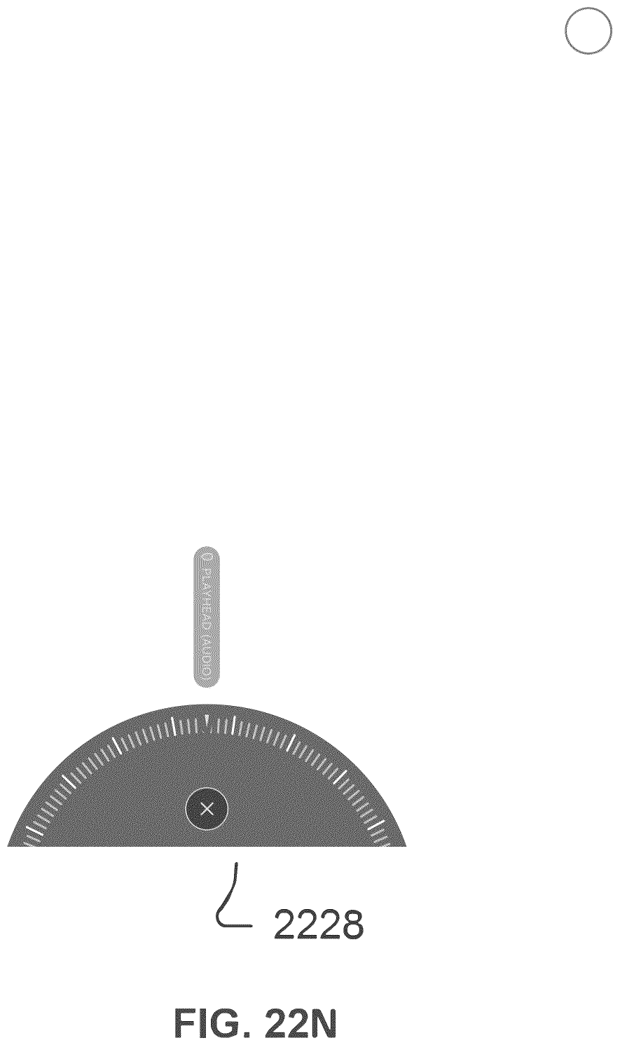

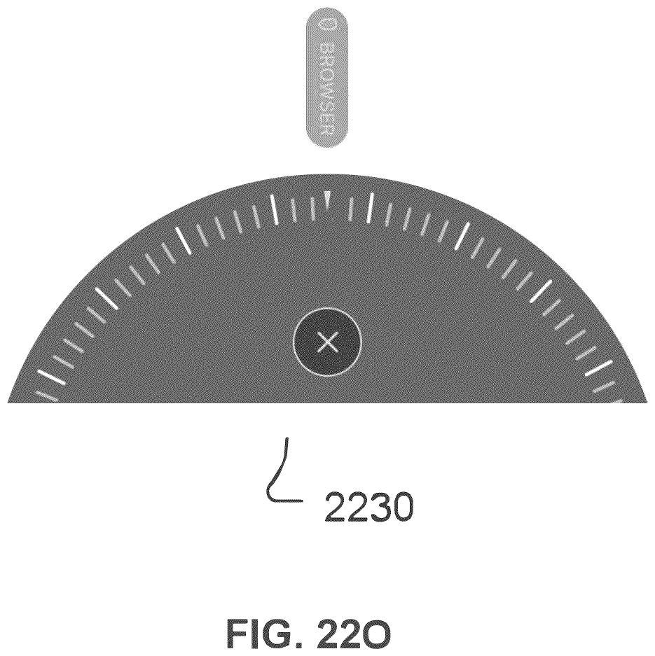

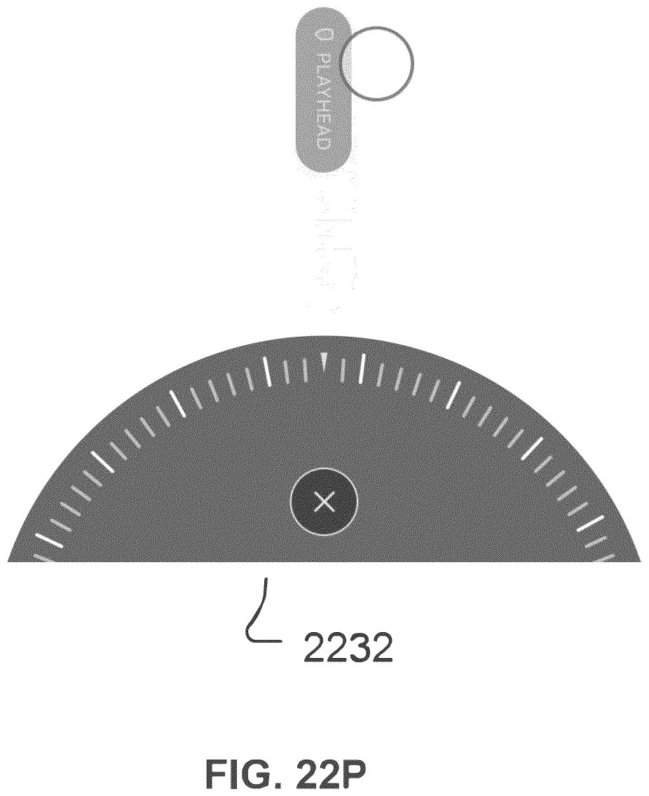

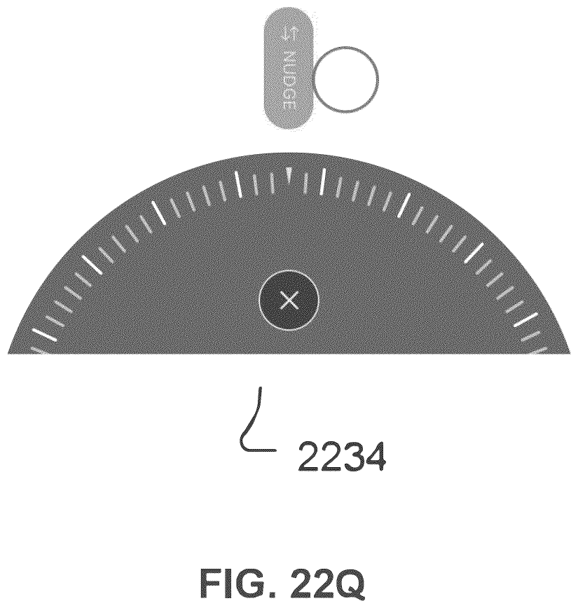

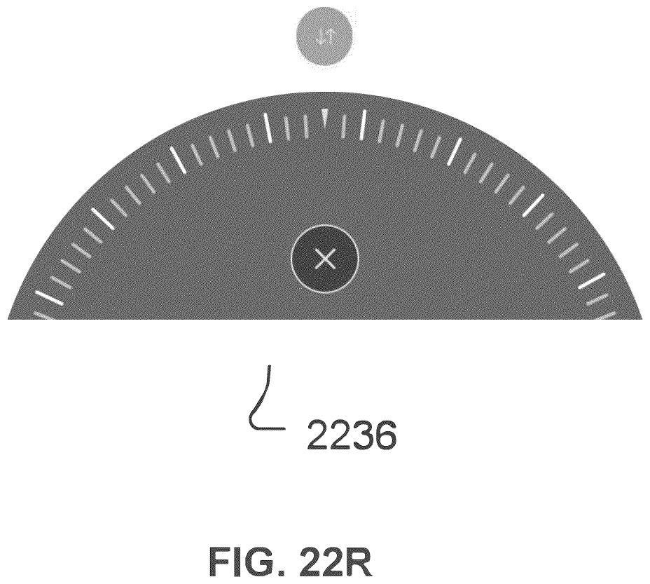

FIG. 22A illustrates an example of a selectable and/or informational UI element 2202 that may be associated with a jog wheel UI element.

FIG. 22B illustrates an example of a selectable and/or informational UI element 2204 that may be associated with a jog wheel UI element.

FIG. 22C illustrates an example of a selectable and/or informational UI element 2206 that may be associated with a jog wheel UI element.

FIG. 22D illustrates an example of a selectable and/or informational UI element 2208 that may be associated with a jog wheel UI element.

FIG. 22E illustrates an example of a selectable and/or informational UI element 2210 that may be associated with a jog wheel UI element.

FIG. 22F illustrates an example of a selectable and/or informational UI element 2212 that may be associated with a jog wheel UI element.

FIG. 22G illustrates an example of a text description UI element associated with a jog wheel UI element 2214.

FIG. 22H illustrates an example of a current position indicator UI element associated with a jog wheel UI element 2216.

FIG. 22I illustrates an example of a text description UI element and a current position indicator UI element associated with an isometric and/or three-dimensional display of a jog wheel UI element 2218.

FIG. 22J illustrates an example of a text description UI element and a current position indicator UI element associated with an isometric and/or three-dimensional display of a jog wheel UI element 2220.

FIG. 22K illustrates an example of a text description UI element and a current position indicator UI element associated with a jog wheel UI element 2222.

FIG. 22L illustrates an example of a text description UI element and a current position indicator UI element associated with a jog wheel UI element 2224.

FIG. 22M illustrates an example of a text description UI element and a current position indicator UI element associated with a jog wheel UI element 2226.

FIG. 22N illustrates an example of a text description UI element and a current position indicator UI element associated with a jog wheel UI element 2228.

FIG. 22O illustrates an example of a text description UI element and a current position indicator UI element associated with a jog wheel UI element 2230.

FIG. 22P illustrates an example of a text description UI element and a current position indicator UI element associated with a jog wheel UI element 2232.

FIG. 22Q illustrates an example of a text description UI element and a current position indicator UI element associated with a jog wheel UI element 2234.

FIG. 22R illustrates an example of a graphical UI element and a current position indicator UI element associated with a jog wheel UI element 2236.

### Graphical User Interfaces

This disclosure above describes various GUIs for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

While FIGS. 1-15 show use of the jog wheel UI element with respect to a GUI for a particular media editing application, any application may benefit from the use of the jog wheel UI element for receiving user input. Some other functionality that may use a jog wheel UI element include, but are not limited to, manual focus of a camera, F-stop adjustment for a camera, image and video parameter adjustments, navigational inputs to browse content (webpages, images in a photo library, files in a directory, etc.), adjusting rotation of an image, video, media, etc., adjusting a size of a graphical element in a GUI, adjusting a size of an image, video, media, etc., moving and/or placing an object in a GUI, pixel-by-pixel adjustment of an image/video, playhead manipulation along a timeline, volume adjustments, etc.

### Privacy

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

### Example System Architecture

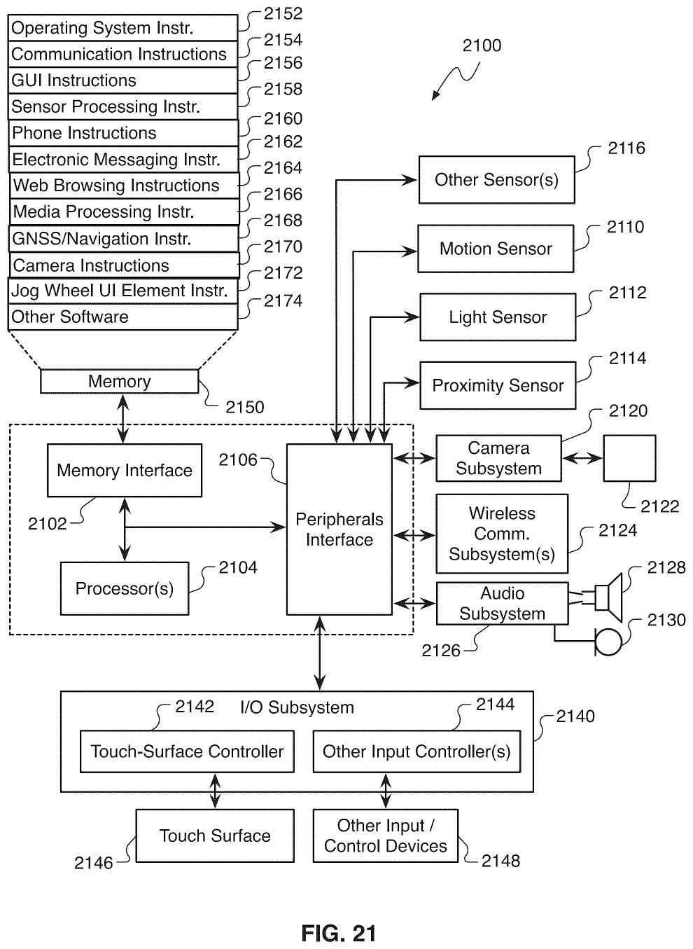

FIG. 21 is a block diagram of an example computing device 2100 that can implement the features and processes of FIGS. 1-20. The computing device 2100 can include a memory interface 2102, one or more data processors, image processors and/or central processing units 2104, and a peripherals interface 2106. The memory interface 2102, the one or more processors 2104 and/or the peripherals interface 2106 can be separate components or can be integrated in one or more integrated circuits. The various components in the computing device 2100 can be coupled by one or more communication buses or signal lines.

Sensors, devices, and subsystems can be coupled to the peripherals interface 2106 to facilitate multiple functionalities. For example, a motion sensor 2110, a light sensor 2112, and a proximity sensor 2114 can be coupled to the peripherals interface 2106 to facilitate orientation, lighting, and proximity functions. Other sensors 2116 can also be connected to the peripherals interface 2106, such as a global navigation satellite system (GNSS) (e.g., GPS receiver), a temperature sensor, a biometric sensor, magnetometer or other sensing device, to facilitate related functionalities.

A camera subsystem 2120 and an optical sensor 2122, e.g., a charged coupled device (CCD) or a complementary metal-oxide semiconductor (CMOS) optical sensor, can be utilized to facilitate camera functions, such as recording photographs and video clips. The camera subsystem 2120 and the optical sensor 2122 can be used to collect images of a user to be used during authentication of a user, e.g., by performing facial recognition analysis.

Communication functions can be facilitated through one or more wireless communication subsystems 2124, which can include radio frequency receivers and transmitters and/or optical (e.g., infrared) receivers and transmitters. The specific design and implementation of the communication subsystem 2124 can depend on the communication network(s) over which the computing device 2100 is intended to operate. For example, the computing device 2100 can include communication subsystems 2124 designed to operate over a GSM network, a GPRS network, an EDGE network, a Wi-Fi or WiMax network, and a Bluetooth™ network. In particular, the wireless communication subsystems 2124 can include hosting protocols such that the device 100 can be configured as a base station for other wireless devices.

An audio subsystem 2126 can be coupled to a speaker 2128 and a microphone 2130 to facilitate voice-enabled functions, such as speaker recognition, voice replication, digital recording, and telephony functions. The audio subsystem 2126 can be configured to facilitate processing voice commands, voiceprinting and voice authentication, for example.

The I/O subsystem 2140 can include a touch-surface controller 2142 and/or other input controller(s) 2144. The touch-surface controller 2142 can be coupled to a touch surface 2146. The touch surface 2146 and touch-surface controller 2142 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 2146.

The other input controller(s) 2144 can be coupled to other input/control devices 2148, such as one or more buttons, rocker switches, thumb-wheel, infrared port, USB port, and/or a pointer device such as a stylus. The one or more buttons (not shown) can include an up/down button for volume control of the speaker 2128 and/or the microphone 2130.

In one implementation, a pressing of the button for a first duration can disengage a lock of the touch surface 2146; and a pressing of the button for a second duration that is longer than the first duration can turn power to the computing device 2100 on or off. Pressing the button for a third duration can activate a voice control, or voice command, module that enables the user to speak commands into the microphone 2130 to cause the device to execute the spoken command. The user can customize a functionality of one or more of the buttons. The touch surface 2146 can, for example, also be used to implement virtual or soft buttons and/or a keyboard.

In some implementations, the computing device 2100 can present recorded audio and/or video files, such as MP3, AAC, and MPEG files. In some implementations, the computing device 2100 can include the functionality of an MP3 player, such as an iPod™.

The memory interface 2102 can be coupled to memory 2150. The memory 2150 can include high-speed random-access memory and/or non-volatile memory, such as one or more magnetic disk storage devices, one or more optical storage devices, and/or flash memory (e.g., NAND, NOR). The memory 2150 can store an operating system 2152, such as Darwin, RTXC, LINUX, UNIX, OS X, WINDOWS, or an embedded operating system such as VxWorks.

The operating system 2152 can include instructions for handling basic system services and for performing hardware dependent tasks. In some implementations, the operating system 2152 can be a kernel (e.g., UNIX kernel). In some implementations, the operating system 2152 can include instructions for providing a jog wheel UI element. For example, operating system 2152 can implement the jog wheel UI element features as described with reference to FIGS. 1-20.

The memory 2150 can also store communication instructions 2154 to facilitate communicating with one or more additional devices, one or more computers and/or one or more servers. The memory 2150 can include graphical user interface instructions 2156 to facilitate graphic user interface processing; sensor processing instructions 2158 to facilitate sensor-related processing and functions; phone instructions 2160 to facilitate phone-related processes and functions; electronic messaging instructions 2162 to facilitate electronic-messaging related processes and functions; web browsing instructions 2164 to facilitate web browsing-related processes and functions; media processing instructions 2166 to facilitate media processing-related processes and functions; GNSS/Navigation instructions 2168 to facilitate GNSS and navigation-related processes and instructions; and/or camera instructions 2170 to facilitate camera-related processes and functions.

The memory 2150 can store software instructions 2172 to facilitate other processes and functions, such as the jog wheel UI element processes and functions as described with reference to FIGS. 1-20.

The memory 2150 can also store other software instructions 2174, such as web video instructions to facilitate web video-related processes and functions; and/or web shopping instructions to facilitate web shopping-related processes and functions. In some implementations, the media processing instructions 2166 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 2150 can include additional instructions or fewer instructions. Furthermore, various functions of the computing device 2100 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A method comprising:
displaying a partial view of a jog wheel user interface (UI) element on a graphical user interface (GUI), wherein the jog wheel UI element is associated with display of one or more media content items;
receiving a touch swipe input for controlling the jog wheel UI element;
responsive to the touch swipe input:
animating a rotation of the jog wheel UI element based on the touch swipe input, wherein rotation of the jog wheel UI element comprises:
(a) rotating the jog wheel UI element at an initial rotational speed that is based on the touch swipe input, wherein the jog wheel UI element continues to rotate subsequent to cessation of the touch swipe input, and
(b) subsequent to cessation of the touch swipe input: reducing a rotational speed of the jog wheel UI element until the rotational speed of the jog wheel UI element reaches zero; and
concurrently with animating the rotation of the jog wheel UI element, continuously modifying the display of at least one of the one or more media content items, wherein a rate of modification for modifying the display of the at least one of the one or more media content items corresponds to the rotational speed of the jog wheel UI element.

2. The method as recited in claim 1, further comprising:
determining an approximate direction of the touch swipe input; and
mapping the approximate direction of the touch swipe input to one of: a clockwise rotation of the jog wheel UI element or a counter-clockwise rotation of the jog wheel UI element,
wherein animating the rotation of the jog wheel UI element comprises rotating at least a circular element of the jog wheel UI element in one of a clockwise direction or a counter-clockwise direction based on the mapping operation.

3. The method as recited in claim 1, wherein reducing the rotational speed of the jog wheel UI element until the rotational speed of the jog wheel UI element reaches zero comprises immediately stopping the rotation of the jog wheel UI element when a stop flag associated with the one or more media content items is reached while modifying the display of the one or more media content items.

4. The method as recited in claim 1, wherein reducing the rotational speed of the jog wheel UI element until the rotational speed of the jog wheel UI element reaches zero comprises linearly reducing the rotational speed at a constant rate or at a declining rate.

5. The method as recited in claim 1, wherein reducing the rotational speed of the jog wheel UI element until the rotational speed of the jog wheel UI element reaches zero comprises reducing the rotational speed at a declining rate.

6. The method as recited in claim 1, wherein modifying the display of the at least one of the one or more media content items comprises modifying one or more of:
an image characteristic of the at least one of the one or more media content items;
a currently displayed media content item of the one or more media content items; or
an audio characteristic associated with the at least one of the one or more media content items.

7. The method as recited in claim 1, further comprising:
concurrently with animating the rotation of the jog wheel UI element, outputting audio clicks at a frequency that is proportional to the rotational speed of the jog wheel UI element.

8. The method as recited in claim 1, wherein a degree of the rotation of the jog wheel UI element is proportional to a length of the touch swipe input.

9. The method as recited in claim 1, wherein one or more characteristics of the jog wheel UI element are adjustable.

10. A non-transitory computer readable medium comprising instructions which, when executed by one or more hardware processors, causes performance of a set of operations comprising:
displaying a partial view of a jog wheel user interface (UI) element on a graphical user interface (GUI), wherein the jog wheel UI element is associated with display of one or more media content items;
receiving a touch swipe input for controlling the jog wheel UI element;
responsive to the touch swipe input:
animating a rotation of the jog wheel UI element based on the touch swipe input, wherein rotation of the jog wheel UI element comprises:
(a) rotating the jog wheel UI element at an initial rotational speed that is based on the touch swipe input, wherein the jog wheel UI element continues to rotate subsequent to cessation of the touch swipe input, and
(b) subsequent to cessation of the touch swipe input: reducing a rotational speed of the jog wheel UI element until the rotational speed of the jog wheel UI element reaches zero; and
concurrently with animating the rotation of the jog wheel UI element, continuously modifying the display of at least one of the one or more media content items, wherein a rate of modification for modifying the display of the at least one of the one or more media content items corresponds to the rotational speed of the jog wheel UI element.

11. A system comprising:
the one or more hardware processors; and
the non-transitory computer readable medium as recited in claim 10.

12. A method comprising:
displaying a jog wheel UI element on a graphical user interface (GUI);
concurrently with displaying the jog wheel UI element: presenting an arrangement of one or more media content items;
receiving a touch input at a first region of the GUI; and
responsive to the touch input:
determining a distance between: (a) a first location within the GUI that is associated with the first region of the GUI, and (b) a second location that is associated with the jog wheel UI element;
selecting a modification to the arrangement of the one or more media content items based on: a) the distance between the first location and the second location, and b) one or more characteristics of the touch input;
animating a rotation of the jog wheel UI element from a first jog wheel position to a second jog wheel position, a degree of the rotation being based on: a) the distance between the first location and the second location, and b) the one or more characteristics of the touch input; and
concurrently with animating the rotation of the jog wheel UI element from the first jog wheel position to the second jog wheel position, animating the modification to the arrangement of the one or more media content items.

13. The method as recited in claim 12, wherein the one or more characteristics of the touch input comprise a length of a swiping motion of the touch input, and wherein the degree of the rotation of the jog wheel UI element is proportional to the length of the swiping motion.

14. The method as recited in claim 12, wherein the one or more characteristics of the touch input comprise a length of a swiping motion of the touch input, and wherein, for a same particular length of the swiping motion, the degree of the rotation of the jog wheel UI element decreases proportional to the particular length of the swiping motion as the distance between the first location and the second location is increased.

15. The method as recited in claim 12, wherein the one or more characteristics of the touch input comprise a length of a swiping motion of the touch input, and wherein, for a same particular length of the swiping motion, the degree of the rotation of the jog wheel UI element increases proportional to the particular length of the swiping motion as the distance between the first location and the second location is decreased.

16. The method as recited in claim 12, wherein the second location that is associated with the jog wheel UI element is associated with an axis of rotation of the jog wheel UI element.

17. The method as recited in claim 12, wherein the second location that is associated with the jog wheel UI element is associated with a particular tick mark displayed near an edge of the jog wheel UI element.

18. The method as recited in claim 12, wherein the one or more characteristics of the touch input is selected from a group consisting of: a distance between an initial contact point and a last contact point associated with the touch input, an approximate direction of the touch input, a pressure of the touch input, a speed of movement of the touch input.

19. The method as recited in claim 12, wherein one or more characteristics of the jog wheel UI element are adjustable, the one or more characteristics being selected from a group consisting of: a size of the jog wheel UI element, a position of the jog wheel UI element on the GUI, an input response direction of the jog wheel UI element, and a portion of the jog wheel UI element to display on the GUI.

20. A non-transitory computer readable medium comprising instructions which, when executed by one or more hardware processors, causes performance of the method as recited in claim 12.

21. A system comprising:
one or more processors; and
a non-transitory computer readable medium comprising instructions which, when executed by the one or more processors, causes performance of the method as recited in claim 12.
